(19) United States
(12) Patent Application Publication
(10) Pub. No.: US 2003/0154815 A1
(43) Pub. Date: Aug. 21, 2003

(54) Support casing for housing a steering shaft

(76) Inventor: Roland Heiml, Vocklamarkt (AT)

Correspondence Address: WILLIAM COLLARD, COLLARD & ROE, P.C., 1077 NORTHERN BOULEVARD, ROSLYN, NY, 11576, US

(21) Appl. No.: 10/240,891

(22) PCT Filed: Apr. 3, 2001
(86) PCT No.: PCT/AT01/00095

(30) Foreign Application Priority Data
Apr. 6, 2000 (AT) A581/2000
Dec. 21, 2000 (AT) A 2121/2000

(51) Int. Cl. B62D 1/16

(52) U.S. Cl. 74/492; 74/493

(57) ABSTRACT

The invention relates to a bearing box (124) for mounting a steering shaft (15), having a steering column tube (125), as proposed by the invention, at least partially enclosing the steering shaft (15), co-operating with at least two bearing elements (166, 167) arranged between the steering shaft (15) and the steering column tube (125) spaced apart from one another in the longitudinal direction of the steering shaft (15) at the end regions of the steering column tube (125) to mount the steering shaft (15) so that can be displaced in rotation, and the bearing element (166, 167) is provided in the form of at least two bearing parts (183; 184) displaceable relative to one another via an intermediate part (182). The steering column tube (125) and/or the bearing part (183; 184) has an adjustment region, by means of which at least one of the bearing parts (183; 184) of at least one bearing element (166; 167) and/or the steering column tube (125) is displaceable in a direction parallel with the longitudinal direction of the steering shaft (15). At least one bearing part (183; 184) and/or the steering column tube (125) can be adjusted in order to set and conform to a mounted dimension (192) between a point (190) and a measurement marker (191).

The invention relates to a steering column tube for a steering shaft, a bearing element, in particular for mounting a steering shaft, a bearing box and a method of assembling bearing elements with a bearing box, having the features outlined in the generic parts of claims 1, 40, 56, 71, 76, 95 and 104.

Patent specification EP 0 816 204 A1 describes a steering column tube consisting of several punched and bent parts, in which a top part, having a U-shaped cross-section normal to the lengthwise direction with a cambered base and two flat lateral legs with a bottom open end, is mounted on the bottom part, which forms a flat plate. Another substantially flat part is riveted onto the top part, mounted plane-parallel with the bottom part, for stiffening purposes. The top and bottom part are joined to one another exclusively by riveting, and if necessary by spot welding at certain points, by means of the material of the punched and bent parts, without any additional material being used. Each of the two lateral legs has a slot to provide a lengthwise displaceable mounting for the steering column tube. The rectangular bottom part lying flat opposite the top part has tabs for riveting to the top part at two seamless bearing mounting points in which ball bearings are inserted, formed on its ends by a drawing process, in other words by tension-free deformation, which are mounted directly on the top part and bottom part. The bearing elements are inserted in the fixed cylindrical bearing points provided on the steering column tube. The bearing elements are adjusted relative to the bearing points by positioning means, such as a radially extending stop flange, for example. The disadvantage of this approach is that the long legs of the top part make the fitting of assembled parts difficult and the structural design of the steering column tube is highly complex, which gives rise to some difficulties in mass production. Furthermore, the position of the bearing elements pre-determined by the positioning means does not allow any possibility of adjusting the dimensions of a specific mounting space or for compensating for manufacturing tolerances, which means that the individual parts of the steering column tube and bearing points for the resultant bearing box have to be put through expensive finishing processes, such as grinding, etc.

Patent specification DE 692 00 117 T2 describes another steering column tube, made from an integral cut piece, which has tabs on oppositely lying sides along its longitudinal extension, which are joined to one another by a clamping system or clinching or welding to form a cylindrical tube. The disadvantage of this approach is that assembly is relatively complex and automated production is not possible except under difficult conditions and subject to high tolerance deviations.

Another published document, EP 0 926 733 A2, describes a steering column tube for encasing the steering shaft, which consists of a tubular casing having a mounting in its longitudinal extension for fixing the steering shaft in a longitudinally displaceable arrangement and its two opposing front faces have a bearing-receiving point in which a bearing is pressed. The steering column tube also widens to a larger diameter towards the front end of the vehicle. The disadvantage of this arrangement is that the tubular cross-section perpendicular to its longitudinal extension is less stiff than a multi-cornered cross-section. Furthermore, there is no way of compensating for tolerances and achieving a high bearing accuracy of the steering column other than by additional finishing.

The underlying objective of the present invention is to produce a steering column tube of a high stiffness, which is structurally simple to produce in few production steps to within the narrowest limits of tolerance. It should also permit mounting of the steering shaft to a high degree of accuracy and allow compensation for manufacturing tolerance, whilst reducing the number of individual components.

This objective is achieved by the characterising features defined in claim 1. The surprising advantage of this solution resides in the fact that several open profiled cross-sections can be produced from two flat cut pieces, which form a multi-cornered cross-section in a mounting plane perpendicular to its longitudinal extension, thus affording a high stiffness. The top and bottom parts are joined to one another by means of a joining element. e.g. a weld seam, for example, in particular a laser or plasma weld seam, and the fact of applying little and only localised heat enables components, accessories, etc., to be built to a tolerance-free design. Using laser welding also offers the option of pre-assembling components, e.g. made from plastics and similar, and then welding them subsequently, without any deformation whatsoever occurring during the joining process. Exact assembly, centring and/or positioning of the top part and the bottom part in the welding device and/or bending device can be guaranteed by means of the bores and slits provided on the steering column tube, which also enables mass production on an economic and efficient basis whilst keeping to a narrow margin of tolerance.

An embodiment defined in claim 2 is also of advantage because the component is subjected to only a minimum of locally applied heat so that it can be constructed as far as possible free of tolerances.

claim 3 defines another embodiment, whereby a secure and inexpensive joint can be obtained without applying any heat.

An advantageous embodiment defined in claim 4 enables a join to be produced, assisted by increased capillary action, and the low amount of heat applied makes for accurate manufacturing.

Also of advantage is an embodiment defined in claims 5 to 7, which facilitates assembly, particularly production of the joint, and the welding and bending equipment is of a simple design.

In this respect, one embodiment, defined in claim 8, has proved to be of particular advantage because the two parts can be mutually positioned to a significantly lesser degree of accuracy, which considerably simplifies the design of the centring system or positioning system.

Also of advantage is an embodiment defined in claim 9, which reduces the number of different work processes, in particular the welding processes.

As a result of the embodiment defined in claims 10 to 12, the requisite amount of space is made available to accommodate the steering shaft and the stiffness of the structure is increased.

Another embodiment is defined in claims 13 and 14 which ensures optimum assembly of the top part on the bottom part and speeds up assembly.

The advantageous embodiment described in claim 15 enables one production step to be dispensed with, thereby cutting production costs.

The embodiment defined in claim 16 makes producing a joint significantly easier.

Also of advantage is the embodiment defined in claim 17, which results in increased stiffness.

An embodiment defined in claims 18 and 19 is of advantage because it enables the operating height of the steering wheel to be varied.

The advantage of an embodiment as defined in claim 20 is that a high degree of stiffness can be obtained by mounting a reinforcing strip, even with thin and hence slight walls.

An embodiment defined in claim 21 has proved to be of particular advantage and enables accessories, in particular damping elements, to be adapted in a simple manner.

An embodiment defined in claim 22, which enables noise-free adjustment of the length into the end positions of the recess and is gentle on the structure, has also been found to have advantages.

Another advantageous embodiment defined in claim 23 enables the requisite work processes to be reduced, making production more economical.

Another possible embodiment is defined in claim 24, which enables the use of standard and hence inexpensive cylindrical tubes.

The embodiment described in claim 25 makes for simple assembly and also simplifies the structure of the welding and bending equipment, etc..

Another advantageous embodiment is defined in claims 26 and 27, which makes the bearing receiving points much easier to produce and reduces the number of individual components.

As defined in claim 28, the sleeve is guaranteed to be centrally received and exactly guided.

Also of advantage is an embodiment defined in claim 29, which prevents any further deviations from predefined tolerances because the temperature can be kept relatively low during the welding process.

The embodiment defined in claim 30 makes for a space-saving and compact design of the steering column tube with a low component weight.

Also of advantage is the embodiment defined in claim 31, because a joining element produced by means of an adhesive is not susceptible to faults as might otherwise be the case due to inclusions of oxygen, etc., during welding.

The embodiments described in claims 32 and 33 enable exact production of the steering column tube due to the low amount of heat applied.

Also of advantage is an embodiment as defined in claim 34, which reduces the number of individual components and work processes and hence production costs.

An embodiment as defined in claim 35 is of advantage since the bearing receiving points are easy to mount on the steering column tube.

Also of advantage is an embodiment defined in claim 36, which enables exact positioning and centring on the machinery, in particular bending and welding devices.

Finally, an embodiment defined in claim 37 is of advantage since it enables any manufacturing tolerances in the longitudinal direction of the steering column to be compensated.

claim 38 defines a cutout receiving and guiding an adjustment mechanism and has a predefined stop surface in the end regions, which reduces the complexity of adapting the adjustment mechanism on the steering column tube.

The embodiment defined in claim 39 is also of advantage because it enables the stiffness to be positively influenced by selecting a suitable height ratio.

The objective of the invention is also achieved by the features set out in the characterising part of claim 40. The surprising advantages of this approach are that several open profiled cross-sections or parts can expediently be produced by means of two flat cut parts, which form a multi-cornered cross-section in a receiving plane perpendicular to the longitudinal extension, thereby obtaining a high degree of stiffness. The first and the other part are joined to one another by means of a joining element, such as a weld seam, in particular a laser or plasma weld seam, for example, so that only a low amount of local heat has to be applied. By forming the receiving regions for the bearing elements, in particular the bearing receiving points, integrally on the steering column tube, the number of individual components and the number of joining processes, in particular welding processes, can be further reduced.

The embodiments defined in claims 41 and 42 enable the use of simply constructed bending presses, which above all allow parts to be produced in large quantities and at low manufacturing costs.

An embodiment defined in claim 43 enables a standardised, inexpensive component to be used.

Also of advantage are the embodiments defined in claims 44 and 45, which enable the shaping forces needed to produce the receiving regions in a bending die to be kept low.

Also of advantage is an embodiment as defined in claim 46, whereby the steering column tube is produced with the bearing receiving points by means of two cut and/or punched and/or bent parts, for example, and the edges produced by bending are received in the joining region of the bearing receiving points due to the diametrically opposed layout of the material recesses.

In an embodiment defined in claim 47, the bending forces needed to produce the receiving region are reduced.

Also of advantage is an embodiment defined in claim 48, whereby the receiving regions are formed directly by the steering column tube and no additional shaping processes are needed to produce the bearing receiving points, nor is it necessary to provide specific bearing receiving points.

The embodiment defined in claim 49 makes for cost-effective production of the steering column tube.

As a result of the embodiments defined in claims 50 to 54, a steering column tube is obtained which has a high degree of stiffness along the entire length and requires few components.

Also of advantage is an embodiment as claimed in claim 55, whereby the component is subjected to only a low amount of local heat, thereby resulting in a construction that is as far as possible free of tolerances.

The objective of the invention is also achieved by the features set out in the characterising part of claim 56. The surprising advantage of this approach is that at least one of the bearing parts is provided with an adjustment region for making adjustments on and relative to the steering column tube, whereby the bearing element can be adjusted and/or positioned in its relative position to the steering column tube as required.

Also of advantage are the embodiments defined in claims 57 to 59, which enable a more precise, less expensive bearing part to be produced using a production method known from the prior art and to a high degree of manufacturing accuracy.

The embodiments defined in claims 60 to 62 enable the bearing parts to be manufactured in large quantities at low production costs.

Also of advantage are the embodiments defined in claims 63 and 64, which enable the mounting space to be adapted and/or the stiffness of the bearing element to be increased.

Also of advantage are the embodiments defined in claims 65 and 66, whereby individual part-sections of the bearing part can be made from a different material if necessary, for example one with a higher bearing capacity. This enables a bearing part to be specifically tailored to different applications.

By pre-setting an adjustment range as described in claim 67, a requisite adjustment path can be defined in order to compensate for manufacturing tolerances or to conform to a pre-defined mounting space.

In accordance with claim 68, the bearing part of the bearing element is able to fulfil an additional function, without the complexity of having to use additional means. By specifying a quasi-over dimensioned adjustment range, the steering column tube can be lengthened in a simple manner, in particular using standardises steering column tubes, making them suitable for use on different types of steering systems of a motor vehicle, which might require a specific distance or a particular mounting space, for example.

The embodiment defined in claim 69 facilitates production of the bearing part or outer ring.

Also of advantage is an embodiment defined in claim 70, whereby the bearing element can be continuously adjusted relative to the steering column tube.

The objective of the present invention is also achieved by the features set out in the characterising part of claim 71. The surprising advantage of this approach is that the bearing part or outer ring assigned to the receiving region leaves room for an adjustment range in addition to the width of the overlap of the positioned parts, which is at least the same as or greater in width than the adjustment range of the outer ring, thereby enabling the outer ring to be adjusted relative to the steering column tube on the receiving region.

In the embodiment defined in claim 72, a receiving region is provided by a part-region of the steering column tube, obviating the need to provide additional means for receiving the bearing elements.

The embodiment defined in claim 73 enables the use of a steering column tube with low manufacturing tolerances, which has bearing receiving points at opposing end regions constituting a receiving region for the bearing elements, by means of which manufacturing tolerances can be compensated.

In accordance with claim 74, standardised, inexpensive tubes may be used.

With the pre-set adjustment range defined in claim 75, an adjustment path can be defined in order to compensate for manufacturing tolerances or to conform to a mounting space.

The objective of the invention is also achieved by the features specified in the characterising part of claim 76. Surprisingly, the resultant advantages are that by adjusting and setting at least one of the bearing elements and/or the steering column tube, a specific mounting space can be preserved, for example between a predeterminable point on the steering column tube and a predeterminable measurement marker on the steering shaft. The option of adjusting at least one of the bearing elements on or relative to the steering column tube makes it possible to work to a mounting space to within less than 0.1 mm.

An embodiment defined in claim 77 enables a position of the bearing element, relative to which the steering column tube is adjustable, to be defined in order to keep to the requisite mounting space, which primarily means that any manufacturing inaccuracies of the steering shaft and/or of the steering column tube can be compensated.

claims 78 and 79 enable electronic measuring means known from the prior art to be used as a simple means of automatically detecting a longitudinal distance constituting the mounting space.

The embodiments defined in claims 80 and 81 enable at least one bearing part or outer ring to be freely adjusted relative to the receiving region of the steering column tube.

Also of advantage is an embodiment defined in claim 82, whereby the bearing part or parts on the receiving region of the steering column tube and/or the steering shaft can be kept automatically positioned so that once the bearing part has been positioned, it can be fixed without the need for additional assistance.

The positive engagement of the steering shaft and the inner ring as defined in the embodiments of claims 83 and 84, enables any slight change in the length of the steering column which might occur to be accommodated, so that the steering shaft is not placed under tension between the oppositely lying bearing elements.

Also of advantage are the embodiments defined in claims 85 to 90, whereby inexpensive joining elements known from the prior art may be used as a means of fixing a seating or position of the bearing element relative to the steering column tube.

Another possible way of producing a pressed seam joint or clinched joint is described in claim 91, enabling a non-detachable joint to be obtained without having to apply heat.

Due to the fact that the other bearing element is adjustable, the embodiment defined in claim 92 enables a longitudinal distance to be set between the bearing elements, thus allowing compensation for tolerances without using additional tolerance-compensating elements, such as coil springs, etc., so that a clearance-free adjustment of the mounted steering shaft relative to the steering column tube can be made.

Also of advantage are the embodiments defined in claims 93 and 94, as a result of which the bearing part of the bearing element forms a strip-shaped joint region in conjunction with and between the receiving segments of the receiving region on the steering column tube, making it easy to produce a joint. Furthermore, as the bearing element and the steering column tube are positioned relative to one another, they are guided towards one another in a positive arrangement so that the bearing element and/or steering column tube can be positioned rapidly and without the need for a complex design of positioning mechanisms.

The objective of the invention is also achieved as a result of the features defined in claim 95. The surprising advantages of this solution reside in the fact that providing at least one bearing part of at least one bearing element on the steering column tube means on the one hand that the mechanisms needed to mount the bearing box, for example a positioning mechanism for positioning the bearing part relative to the steering column tube, can be reduced and on the other hand output rates as well as the cost of manufacturing the bearing box can be reduced due to the smaller number of individual components.

The embodiments defined in claims 96 to 98 enable the available mounting space to be adapted or allowance to be made for it.

The embodiments defined in claims 99 and 100 enable standardised, inexpensive components and manufacturing processes to be used.

In accordance with claim 101, the bearing capacity and hence the service life of the bearing box can be increased.

Other possible embodiments are defined in claims 102 and 103, which enable manufacturing costs to be further reduced and manufacturing accuracy to be increased.

Finally, the objective of the invention is also achieved by the features defined in claim 104. The advantage of this solution is that the bearing box can be produced in a few production steps and, because the mounting space is adjusted to a high positional accuracy allowing any clearance to be compensated, and because of the joining elements, it will be substantially maintenance free throughout its entire service life.

Also of advantage are the features defined in claims 105 to 111, as a result of which simple process steps enable a mounting space and/or longitudinal distance to be readily set between two bearing elements, and the longitudinal distance is adjusted on the basis of pre-definable mechanical desired values and the bearing elements are preferably fixed in a non-detachable arrangement, once adjusted, so that the bearing box housing the steering shaft can be designed as a separate unit which can be integrated in a motor vehicle with only a few production steps, which means that the bearing box can be manufactured on production lines as a modular and simple structure to a high production accuracy, which meets the high qualitative demands of the automotive industry.

The invention will be explained in more detail below with reference to examples of embodiments illustrated in the appended drawings.

Of these:

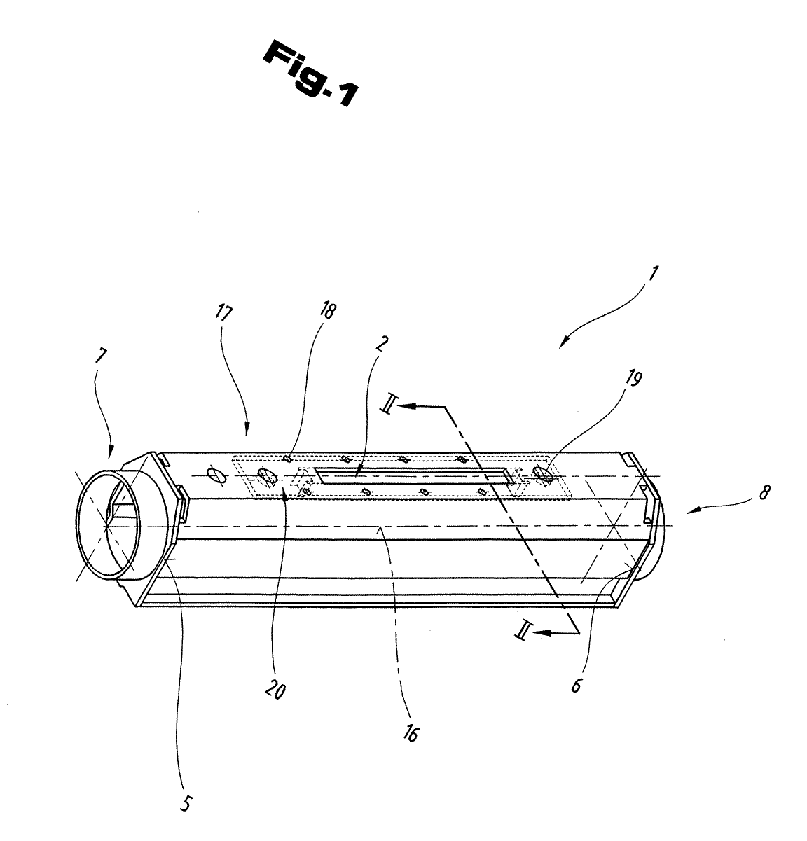

FIG. 1 is a perspective view of the steering column tube with bearing receiving points as proposed by the invention;

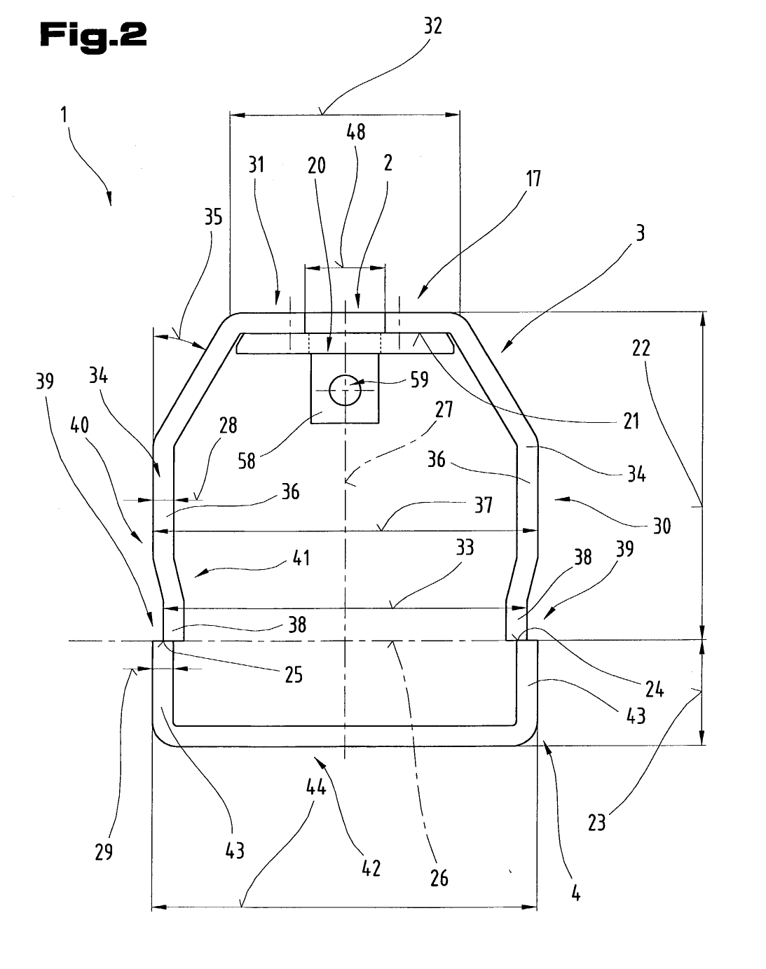

FIG. 2 is a front view of the steering column tube, on an enlarged scale, and seen in section along the line II-II indicated in FIG. 1;

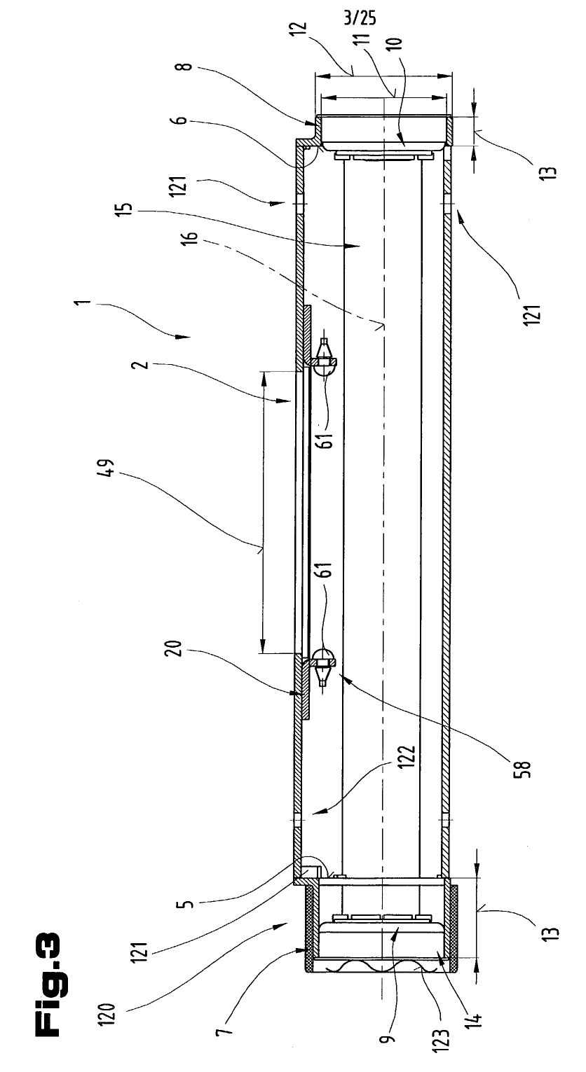

FIG. 3 is a simplified diagram of a steering column tube with bearing receiving points, bearings, reinforcing strip and a sleeve, seen in section from a side view;

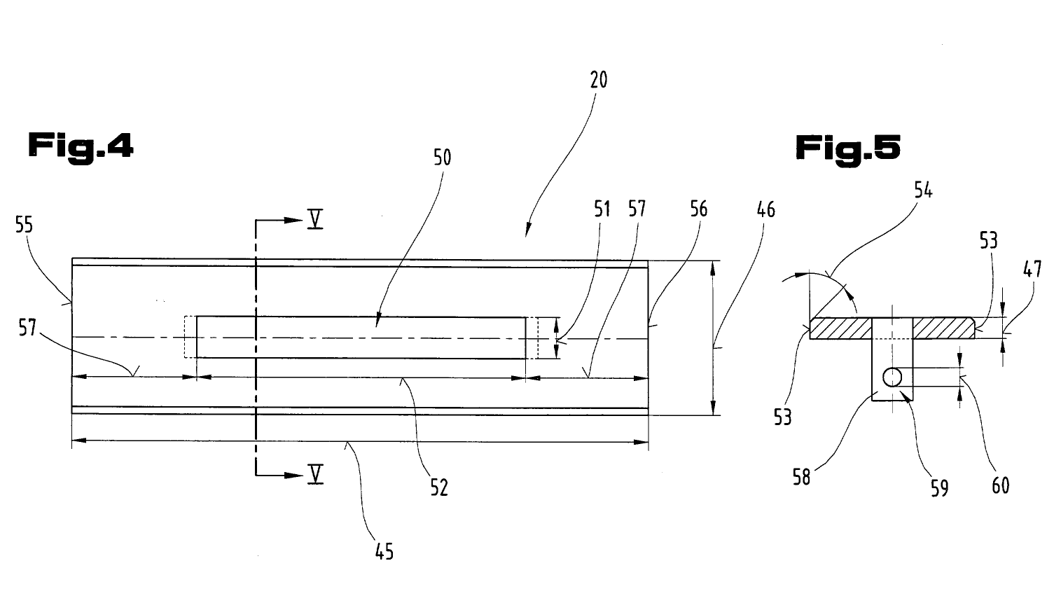

FIG. 4 is an enlarged diagram showing a plan view of the reinforcing strip;

FIG. 5 shows the reinforcing strip, seen in section along the line V-V indicated in FIG. 4;

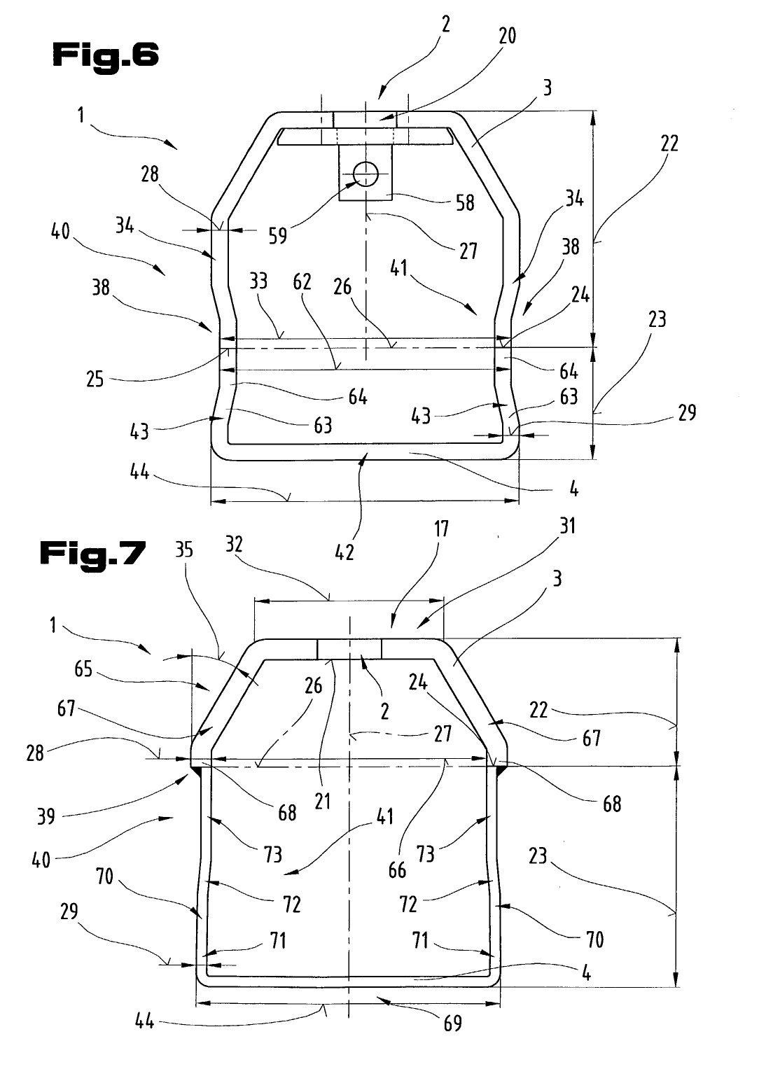

FIG. 6 is a front view, seen in section, of another embodiment of the steering column tube;

FIG. 7 is a front view, seen in section, of another embodiment of the steering column tube;

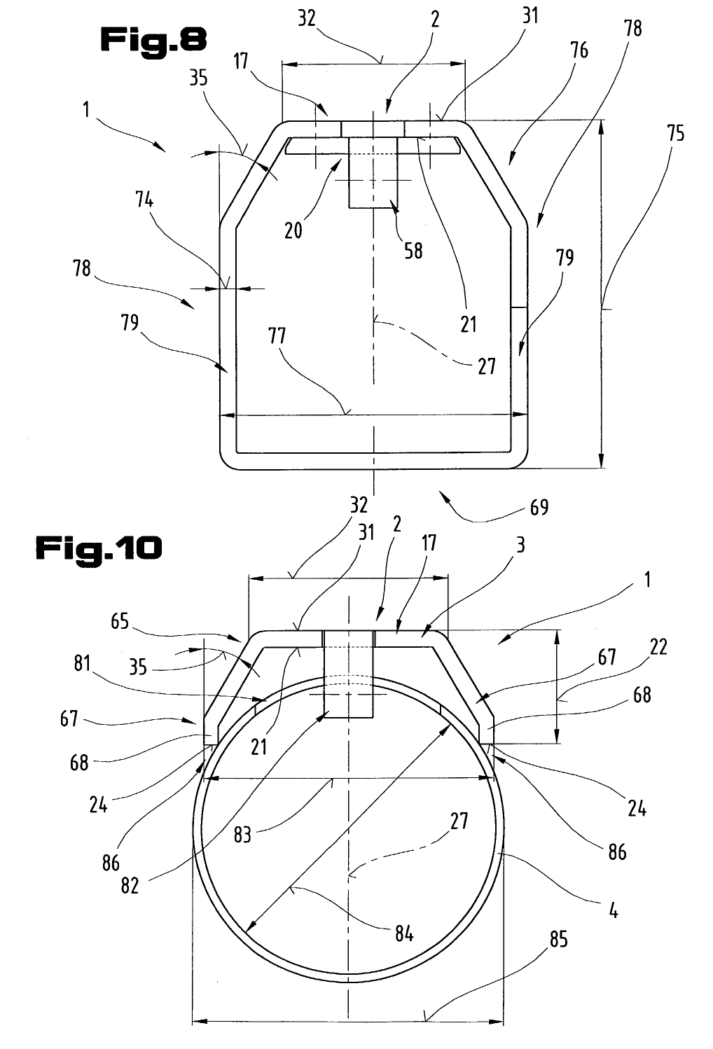

FIG. 8 is a front view, seen in section, of another embodiment of the steering column tube;

FIG. 9 is a simplified diagram showing the steering column tube with upstanding bearing receiving points;

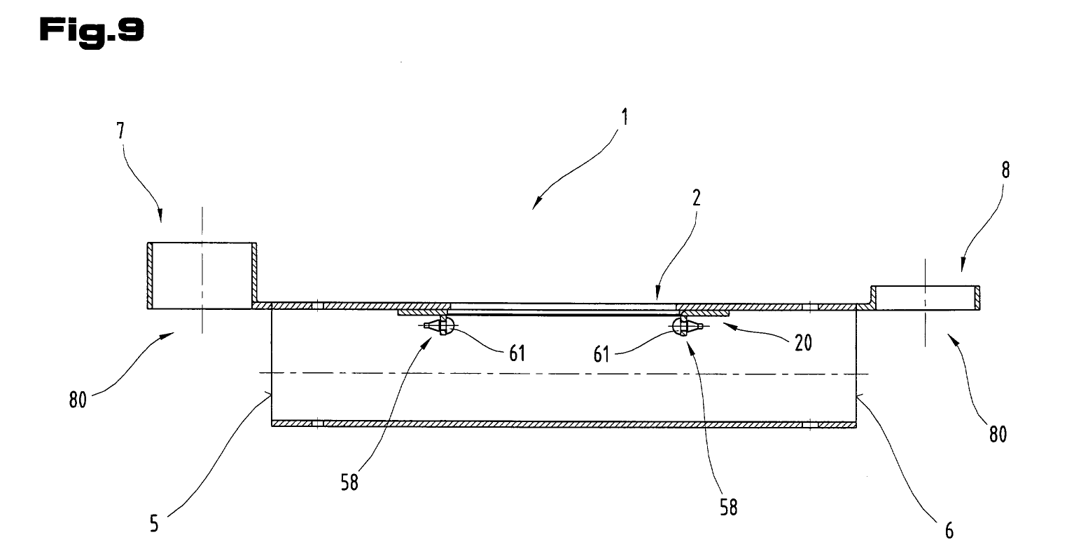

FIG. 10 is a front view, seen in section, of another embodiment of the steering column tube;

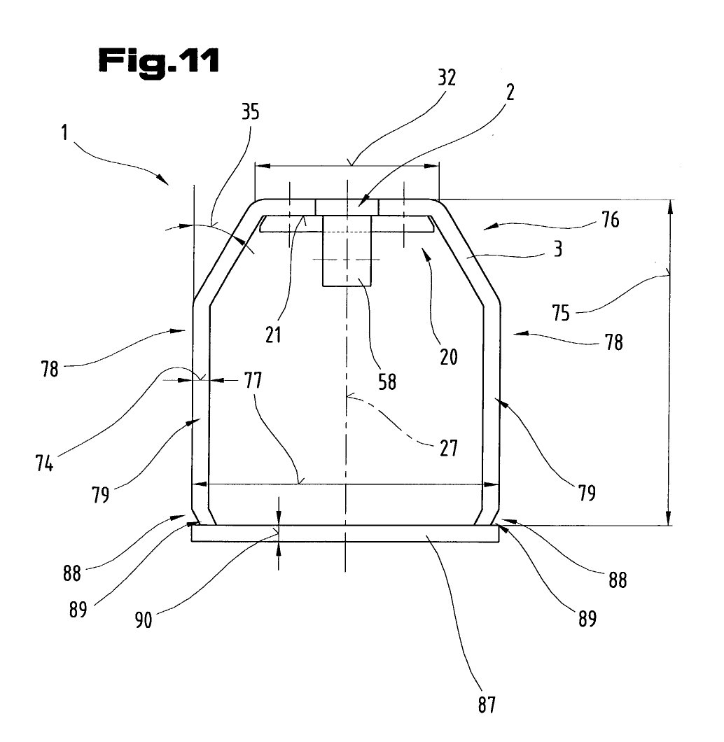

FIG. 11 is a front view, seen in section, of another embodiment of the steering column tube;

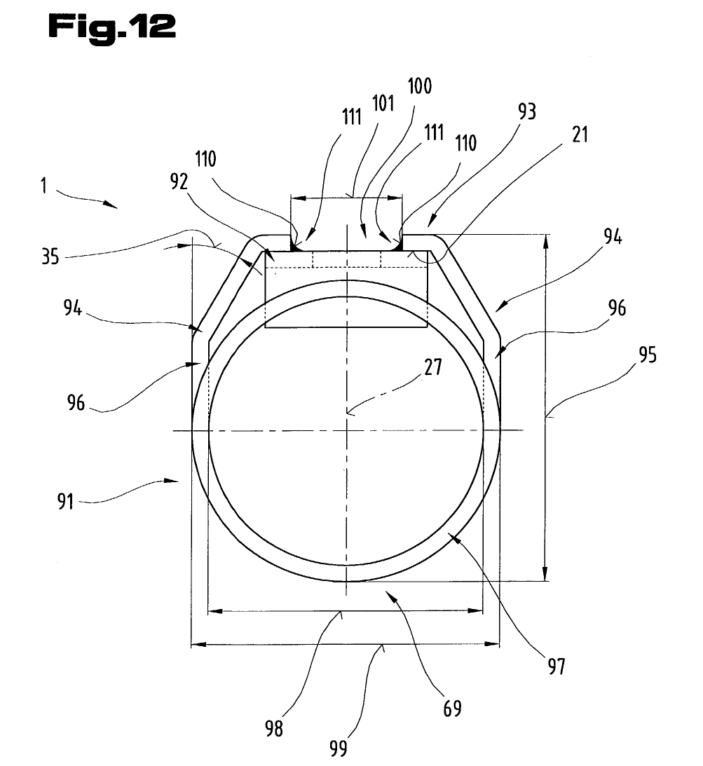

FIG. 12 is a front view, seen in section, of another embodiment of the steering column tube;

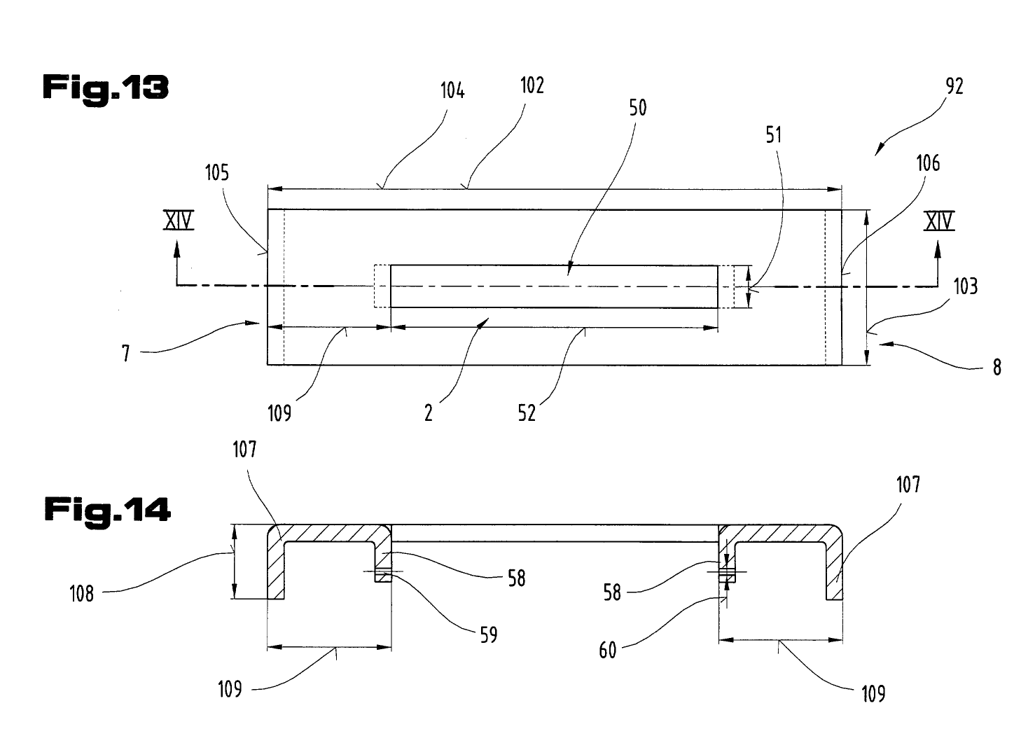

FIG. 13 is a simplified diagram in plan view showing a strip with cutout;

FIG. 14 shows the strip, in section along the line XIV-XIV indicated in FIG. 13;

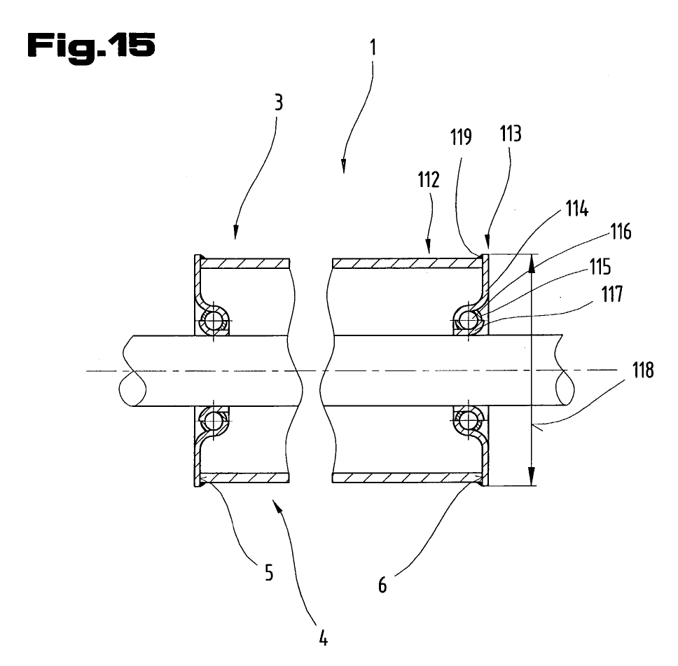

FIG. 15 is a highly simplified diagram of a steering column tube with an outer ring of the bearing integrated at the end faces, seen in section from a side view;

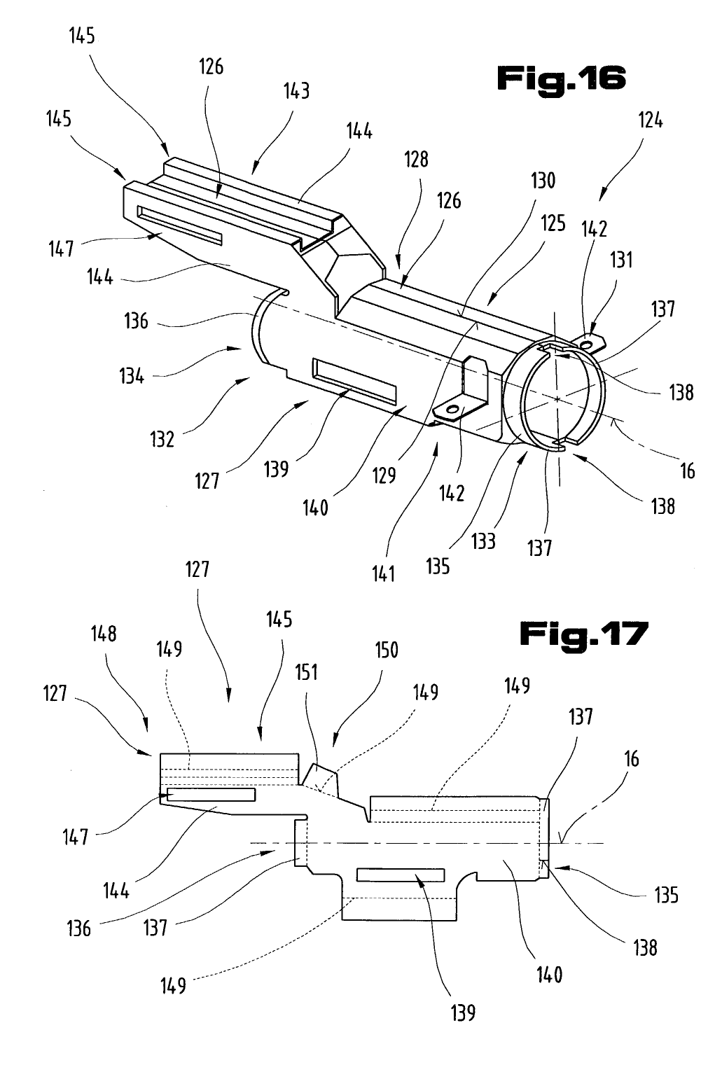

FIG. 16 is a perspective view of another embodiment of a bearing box with a steering column tube and supporting arm, as proposed by the invention;

FIG. 17 is a highly simplified, schematic diagram showing a plan view of a flat cut and/or punched and/or bent part;

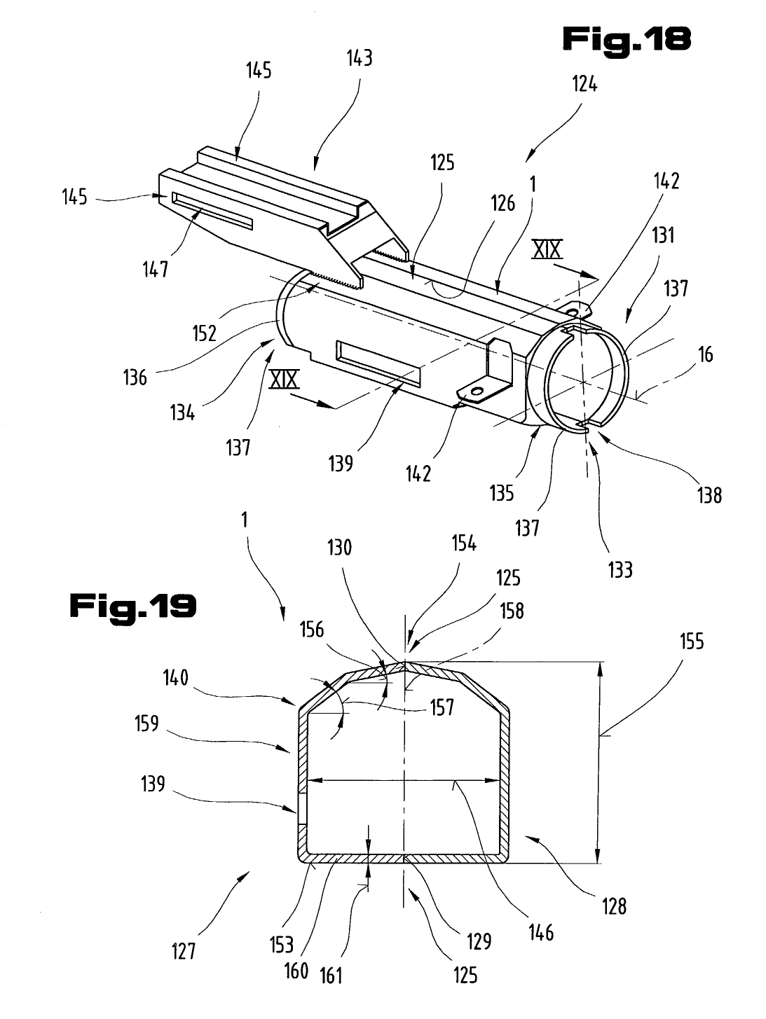

FIG. 18 is a highly simplified, schematic diagram of another embodiment of the bearing box with steering column tube and the supporting arm proposed by the invention, shown in a perspective view;

FIG. 19 is a highly simplified schematic diagram showing a front view of the steering column tube, seen in section along the line XIX-XIX indicated in FIG. 18;

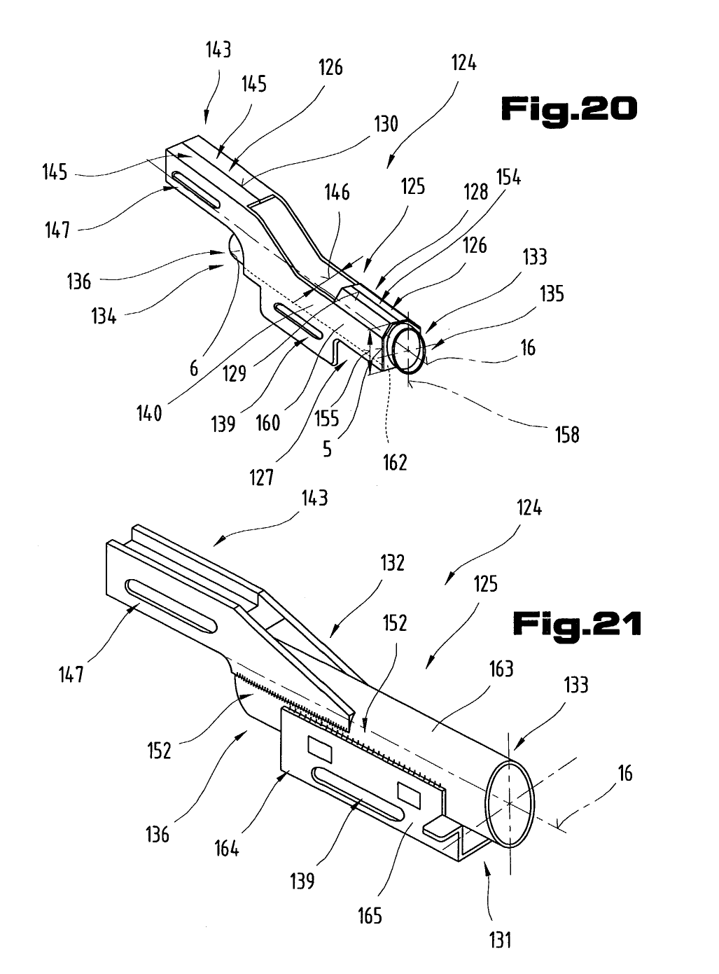

FIG. 20 is a highly simplified, schematic diagram of another embodiment of a bearing box with steering column tube and supporting arm as proposed by the invention, seen in a perspective view;

FIG. 21 is a highly simplified, schematic diagram of another embodiment of a bearing box with steering column tube and supporting arm, seen in a perspective view;

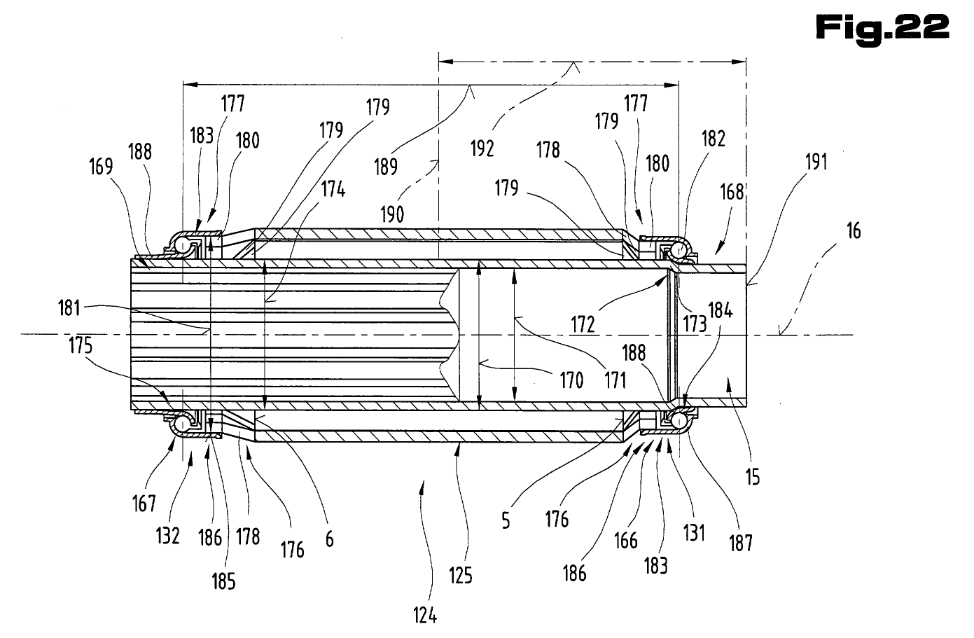

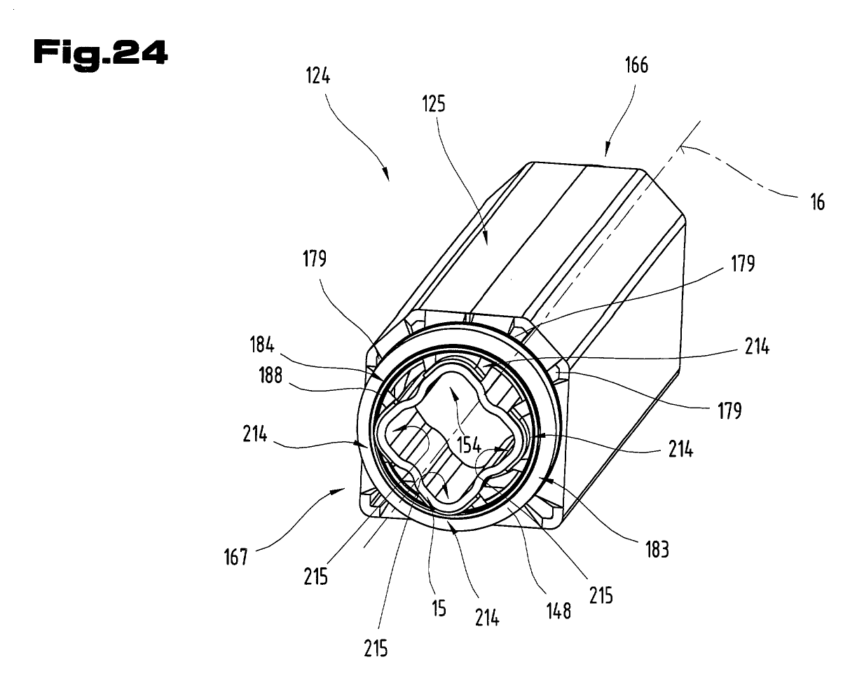

FIG. 22 is a highly simplified, schematic diagram of another embodiment of a bearing box with steering column tube as proposed by the invention, seen in a longitudinal section as shown in FIG. 24, with the bearing elements proposed by the invention;

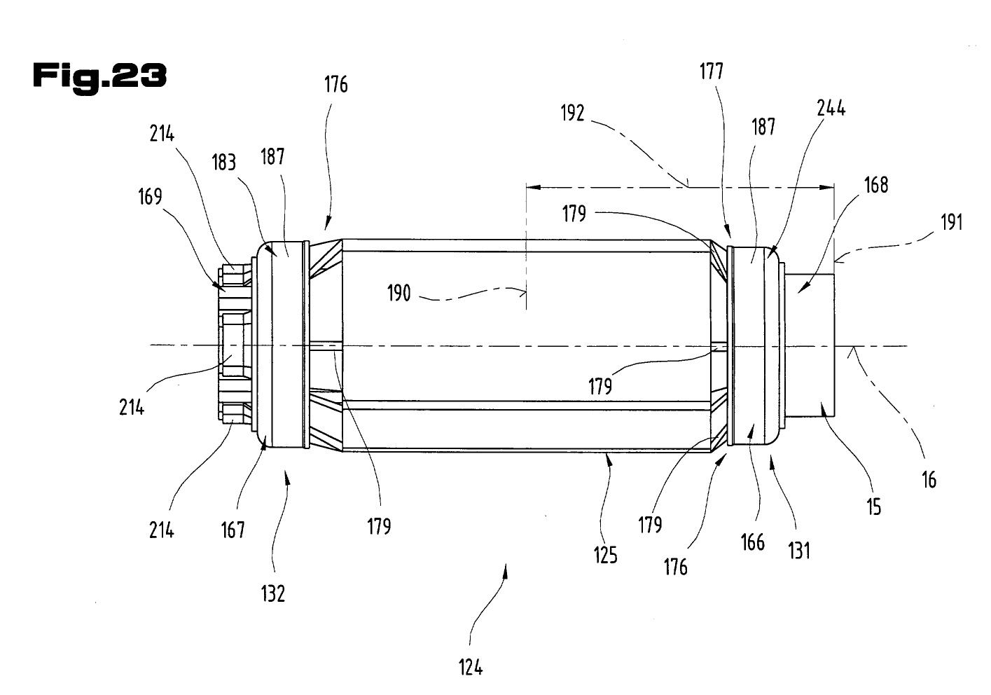

FIG. 23 is a highly simplified schematic diagram showing a side view of the bearing box;

FIG. 24 is a highly simplified schematic diagram showing a perspective view of the bearing box;

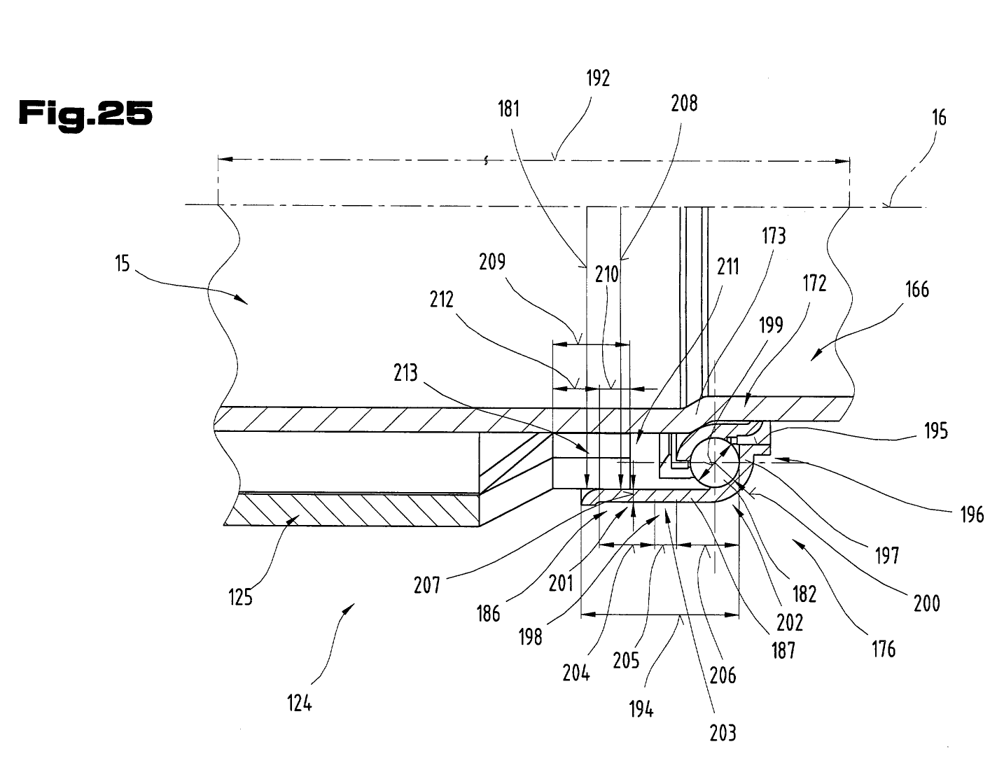

FIG. 25 is a highly simplified, schematic diagram showing a part-region of the receiving region for the bearing element illustrated in FIG. 22, seen in longitudinal section;

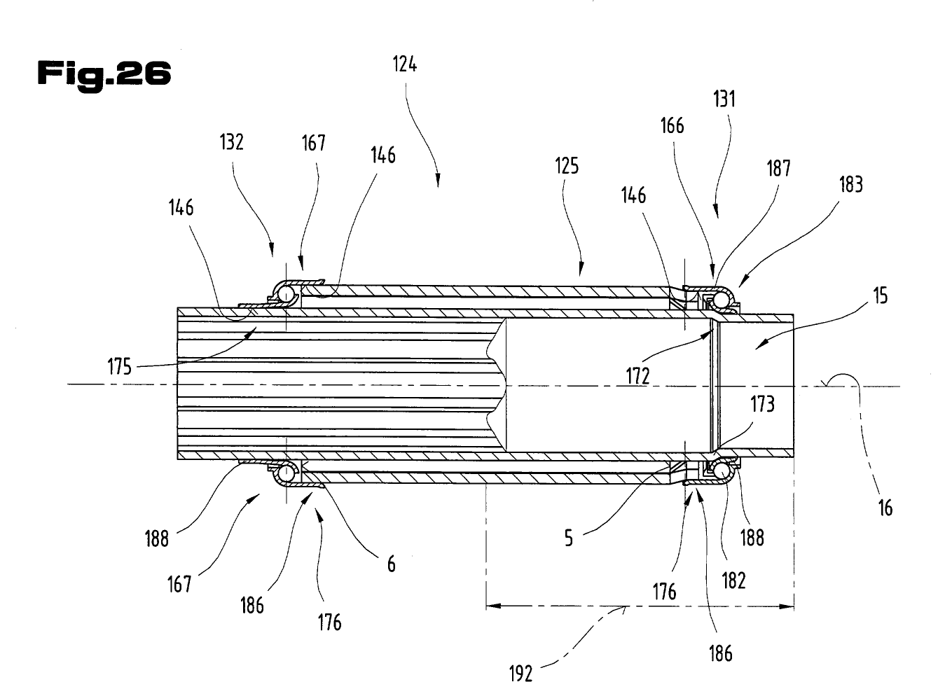

FIG. 26 is a highly simplified, schematic diagram showing the steering column tube and the steering shaft with another embodiment of the arrangement of the bearing elements, seen in longitudinal section;

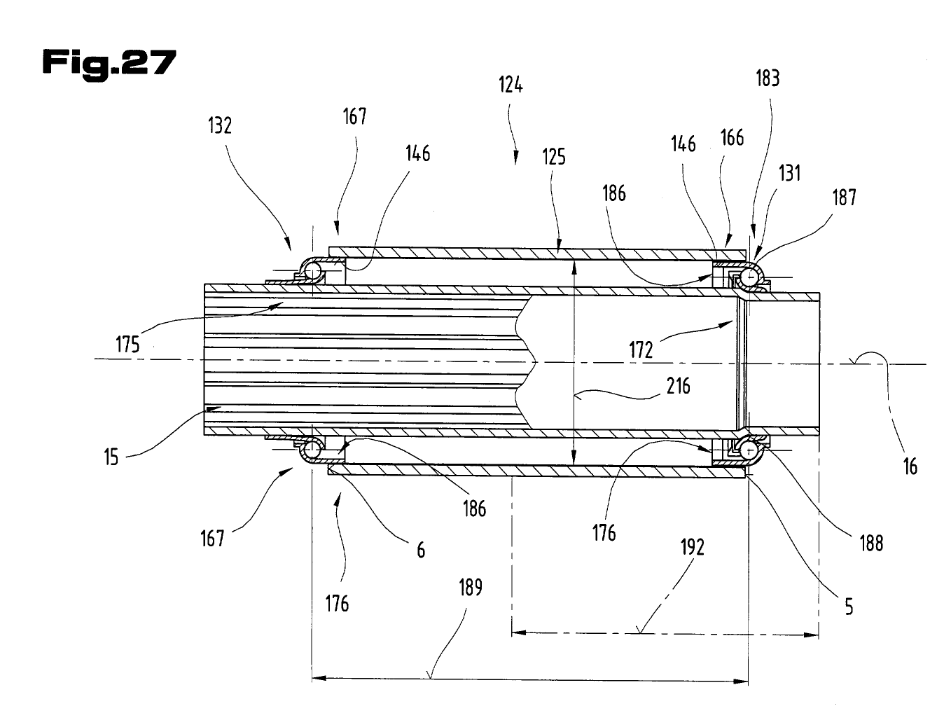

FIG. 27 is a highly simplified, schematic diagram showing the steering column tube and the steering shaft with another embodiment of the layout of the bearing element, seen in longitudinal section;

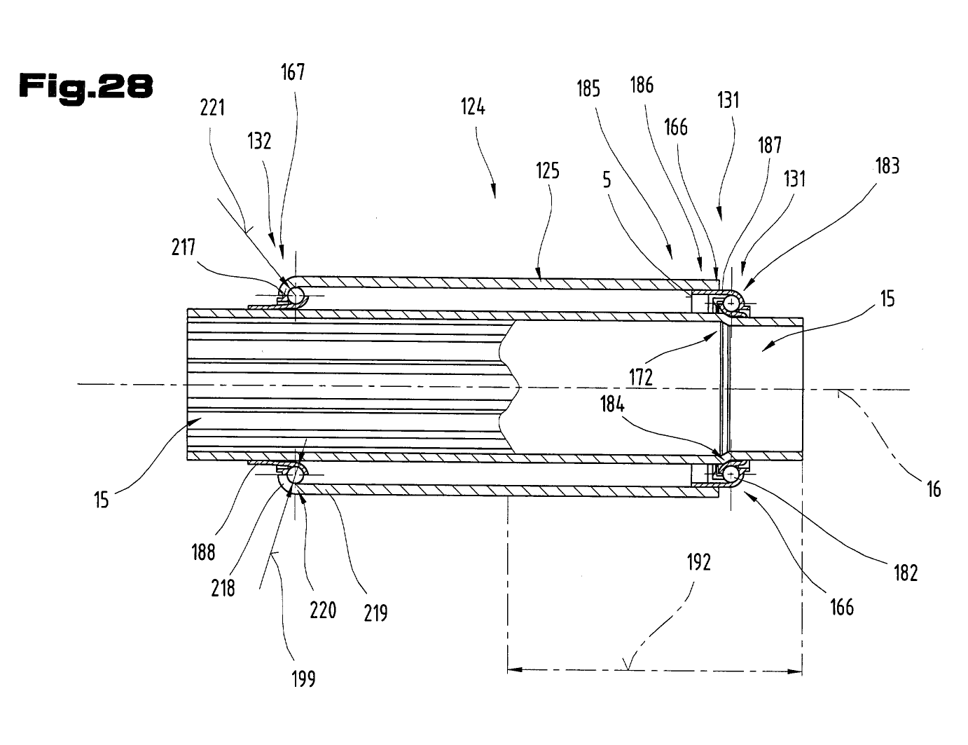

FIG. 28 is a highly simplified, schematic diagram showing a bearing box with a steering shaft and a steering column tube housing it, as proposed by the invention, seen in longitudinal section;

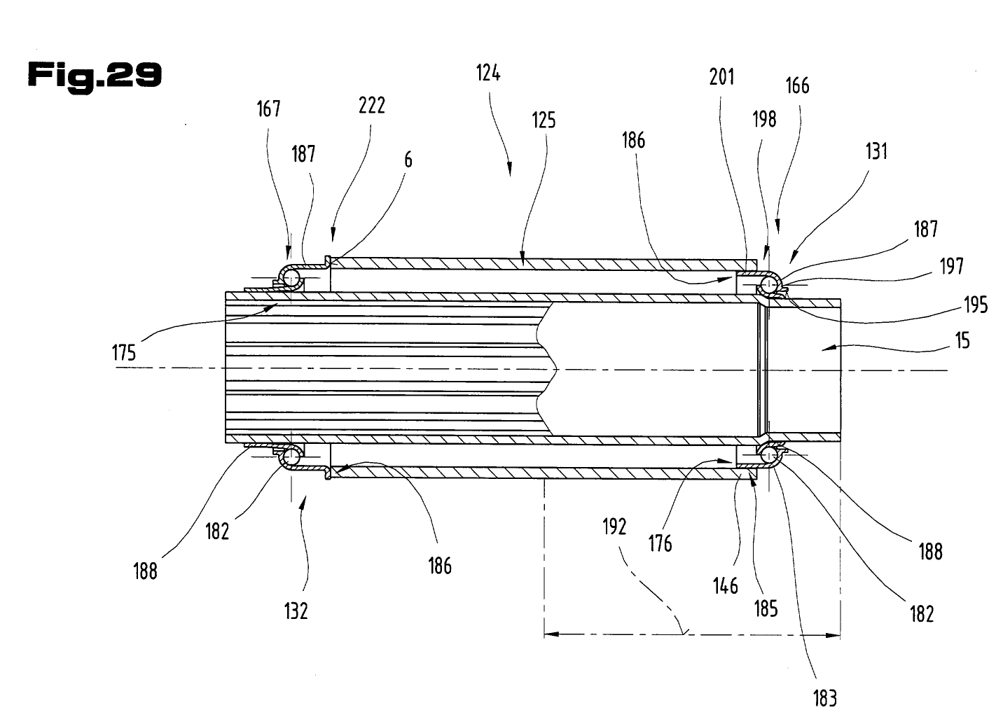

FIG. 29 is a highly simplified, schematic diagram showing the steering column tube and the steering shaft with a different embodiment of the arrangement of the bearing element, seen in longitudinal section;

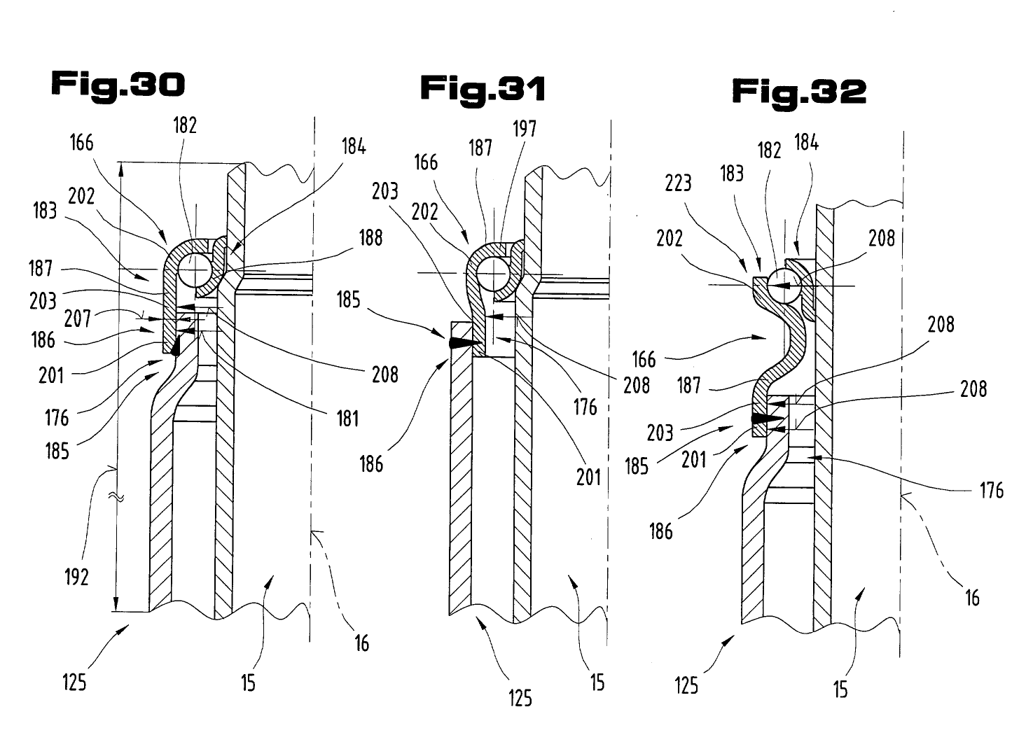

FIG. 30 is a highly simplified, schematic diagram showing a part-region of the bearing box proposed by the invention with another embodiment of the receiving region on an external face of the steering column tube and the bearing element, seen in longitudinal section;

FIG. 31 is a highly simplified, schematic diagram showing a part-region of the bearing box proposed by the invention and another embodiment of the receiving regions on an internal face of the steering column tube and the bearing element, seen in longitudinal section;

FIG. 32 is a highly simplified, schematic diagram showing a part-region of the bearing box proposed by the invention with another embodiment of the receiving region on an external face of the steering column tube and the bearing element, seen in longitudinal section;

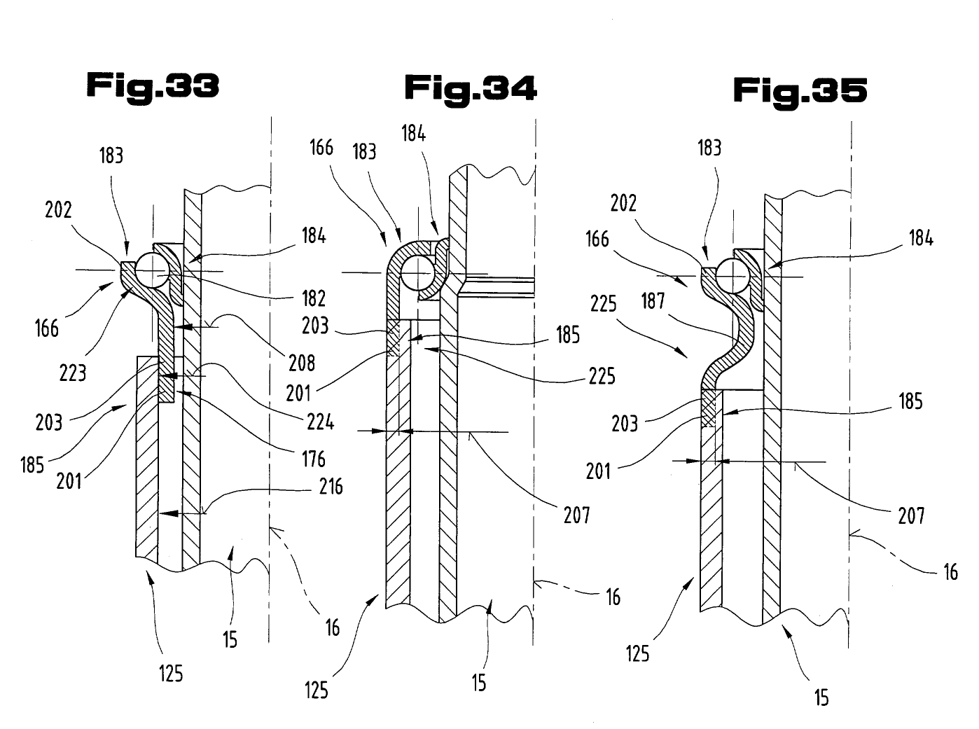

FIG. 33 is a highly simplified, schematic diagram showing a part-region of the bearing box proposed by the invention with another embodiment of the receiving region on an internal face of the steering column tube and the bearing element, seen in longitudinal section;

FIG. 34 is a highly simplified, schematic diagram showing a part-region of the bearing box proposed by the invention with another embodiment of the receiving region between an external and internal face of the steering column tube and the bearing element, seen in longitudinal section;

FIG. 35 is a highly simplified, schematic diagram showing a part-region of the bearing box proposed by the invention with another embodiment of the receiving region between an external and internal face of the steering column tube and the bearing element, seen in longitudinal section;

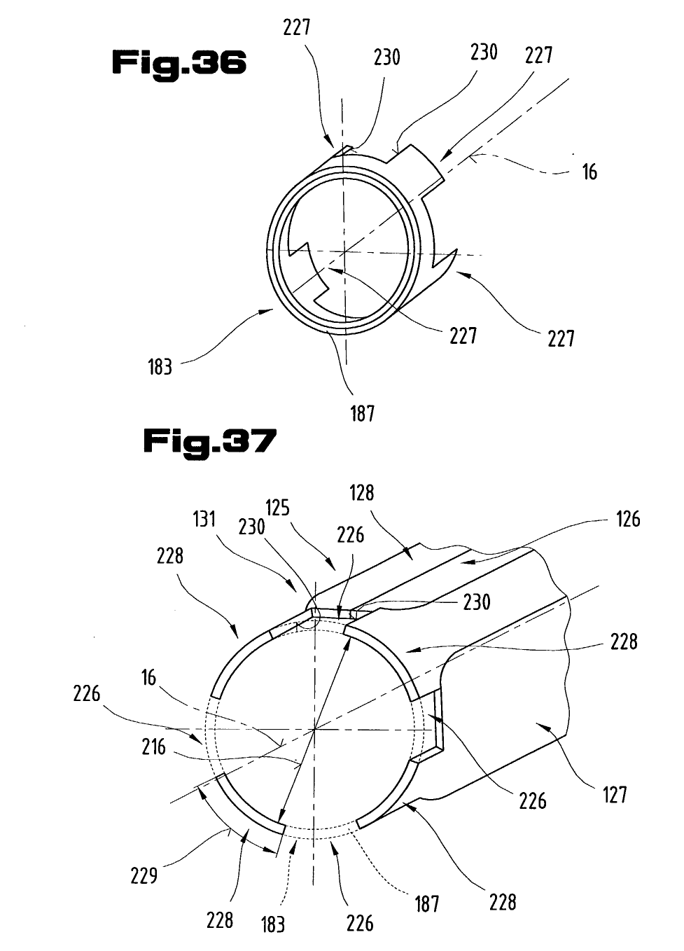

FIG. 36 is a highly simplified, schematic diagram showing a perspective view of the bearing part and outer ring proposed by the invention;

FIG. 37 is a highly simplified, schematic diagram showing a perspective view of the part-region of the steering column tube proposed by the invention with another embodiment of the receiving region proposed by the invention.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc,. relate to the drawing specifically being described and can be transposed in terms of meaning to a new position when another position is being described. Individual features or combinations of features from the different embodiments illustrated and described may be construed as independent inventive solutions or solutions proposed by the invention in their own right.

FIGS. 1 to 15 are highly simplified schematic diagrams, illustrating different perspectives of a steering column tube 1 and receiving regions for bearing elements comprising bearing box and parts thereof. The receiving regions are bearing receiving points. These will be explained in more detail below with reference to specific embodiments.

FIGS. 1 to 5 illustrate a steering column tube 1, consisting of a top part 3 with a cutout 2 and a bottom part 4 lying opposite it. The steering column tube 1, which is used in motor vehicles, for example, has two bearing receiving points 7 and 8 on oppositely lying end-side end faces 5 and 6, which are provided in particular in the form of bearing seating rings or bearing bushes and are mutually joined to the steering column tube 1 by means of a joining element, in particular being welded and/or screwed and/or riveted and/or adhered to one another. The seamless, tubular bearing receiving points 7 and 8 for receiving bearings 9 and 10, in particular ball bearings, have an internal diameter 11 and an external diameter 12 and have a bearing plate joined to the end faces 5, 6. The seamless bearing receiving points 7 and 8, which are of a continuous circular design and have a width 13, form a tubular section which may be made by a rolling process or a deep-drawing process, etc.. By preference, the bearing receiving point 7 or 8, directed towards the driver's cab, has a bigger width than a bearing receiving point 7 or 8 lying opposite it. The bearing receiving points 7 and 8 may be designed so that the bearings 9 and 10 are fixedly joined to the bearing receiving points 7 and 8, for example pressed in, welded on, adhered, etc., and/or an outer ring 14 formed by the bearing 9 and 10 forms a one-part or two-part component with the bearing receiving point 7 and 8. In order to adjust and guide the length of a steering shaft 15 in the direction of a steering shaft mid-line 16, the cutout 2 provided in the top part 3 of the steering column tube 1, which may be a longitudinal groove, longitudinal slot, oblong hole, for example, must be such as to enable the operating position to be varied. A surface 17 of the top part 3 of the steering column tube 1 is provided with several bores 18 and 19 distributed around the periphery in order to connect a reinforcing strip 20 to the steering column housing 1. The purpose of the internally lying reinforcing strip 20 mounted on a base 21 parallel with the steering shaft mid-line 16 is to stiffen the cutout 2 of the top part 3 provided on the surface 17 and is connected to the steering column tube 1 from outside or inside, preferably from outside, by means of a weld joint. Any welding methods may be used to produce the weld joint, in particular arc welding, plasma welding or laser welding, etc., which are capable of producing a join, with or without additional material, between the reinforcing strip 20 and the steering column housing 1, in particular the top part 3 and/or between the top part 3 and the bottom part 4 and/or between the steering column tube 1 and a flat plate of the bearing receiving points 7 and 8, etc..

End faces 24 and 25 of the top part 3 having a height 22 and of the bottom part 4 having a height 23 form an imaginary dividing plane 26 parallel with the surface 17, on which a perpendicular axis of symmetry 27 is disposed. By preference, the height 22 of the top part 3 is bigger than the height 23 of the bottom part 4. A wall thickness 28 of the top part 3 corresponds to a wall thickness 29 of the bottom part 4 and for practical purposes remains constant across an entire cross section 30. The top part 3 with a height 22 has a multi-cornered, for example trapezoid-shaped or U-shaped cross section 30, a width dimension 32 at a top edge 31 of the surface 17 being smaller than an external dimension 33 disposed parallel with the width dimension 32. Parts of side legs 34 between the top edge 31 of the top part 3 and the imaginary dividing plane 26 extend at an incline towards one another in the direction of the height 22 and widen the greater the distance from the base 21 at an angle 35 as far as an intermediate part 36 with an external dimension 37 parallel with the axis of symmetry 27, which has a slight taper in the adjoining region. Adjoining it downstream is an end part 38 parallel with the axis of symmetry 27, which, in conjunction with the two end faces 24 forms the contact point at which the joining element joins with the bottom part 4. By using a uniform wall thickness 28 and 29, an overlap is obtained at the imaginary dividing plane 26 on the end faces 24 and 25 of the top part 3 and the bottom part 4, which may correspond to the half wall thickness 28 and 29, for example. The hollow throat 39 formed by the overlap on an external face 40 lying opposite the axis of symmetry 27 or an internal face 41 of the steering column tube 1 directed towards the axis of symmetry 27 is of enormous advantage in terms of producing a joint, in particular a weld joint. A design of this type simplifies the preparatory work which needs to be done in the broadest sense in order to join the top part 3 and the bottom part 4, since the assembly units can be made to a structurally simpler and more economic design. The assembly work is therefore significantly simpler and faster.

The bottom part 4 with the height 23 forms a U-shaped cross section 42, for example, with two side legs 43 extending parallel with the axis of symmetry 27, the external dimension 44 of which is smaller than, the same as or bigger than the external dimension 33 and may be the same as the external dimension 37. This results in the overlap so that the internal face 41 or the external face 40 protrudes. Naturally, the side legs 34 and 43 could also extend congruently.

The rectangular reinforcing strip 20 disposed in the direction of the steering shaft mid-line 16, having a length 45, a width 46 and a thickness 47, is mounted directly on the base 21 underneath the cutout 2 of the top part 3, which has a width 48 and a length 49. In the direction of the length 45, the reinforcing strip 20 has a cutout 50, in particular a longitudinal groove, the width 51 and length 52 of which are the same as and/or bigger than the length 49 and width 48 of the cutout 2 of the steering column tube 1.

The oppositely lying end faces 53 extending along the length 45 inclined at an angle 54 relative to one another are adapted to the contour of the side legs 34. Two flanges 58 on oppositely lying end-side end faces 55 and 56 aligned at a distance 57 perpendicular to the reinforcing strip 20 have a bore 59 with a diameter 60 for receiving damping elements 61, for example elastomer dampers, air dampers or spring dampers, etc.. Naturally, the damping elements 61 may be mounted on the flanges 58 by any possible types of joint, for example bonding, pressing, clamping, riveting, etc.. The end-position damping afforded by the damping elements 61 is kinder on the structure and additionally ensures that there is a sufficient adjustment path.

The length 52 of the cutout 50 provided in the reinforcing strip 20 may be selected so that the flanges 58 mounted directly underneath the steering column tube 1 are positioned directly flush with and/or at a distance from the start or end of the cutout 2 provided in the steering column tube 1. The flanges 58 may be mounted on the reinforcing strip 20 using any type of mounting, for example riveting, bonding, welding, etc., suitable for the structure. The reinforcing strip 20 may also be made as a cut part, on which the flanges 58 are mounted or upstanding flanges 58 directed towards the steering shaft mid-line 16 are positioned parallel with the axis of symmetry 27. In another embodiment, when making the top part 3 of the steering column tube 1, allowance is made in the material for the flanges 58 in the form of notches which are aligned with the surface 17 of the top part 3 in a subsequent 90° shaping process.

The reinforcing strip 20 is mounted on the cross section 30 in the top part 3 which is weakened by the cutout 2 so that the construction comprising the top part 3 and the bottom part 4 that is more robust and resistant to bending. This design obviates the need to make the overall construction more robust, which in turn makes for a saving in weight and material. The reinforcing strip 20 may be made from the most varied of materials exhibiting the requisite strength, in particular materials such as steels, plastics of any type or glass fibre-reinforced plastics, etc., which may be used in conjunction with any appropriate joining option.

FIG. 6 illustrates another embodiment of the steering column tube 1, which is made in two parts consisting of the top part 3 provided with the cutout 2 and the oppositely lying bottom part 4, which are joined by a joining element. The height 22 of the top part 3 is preferably bigger than the height 23 of the bottom part 4, corresponding to the design illustrated in FIG. 2. The top part 3 has the side legs 34 and the reinforcing strip 20 with the flanges 58 and bores 59 for damping elements 61 (not illustrated in FIG. 6) disposed on the base 21 underneath the cutout 2. The side legs 34 with the wall thickness 28 in the top part 3 have the external dimension 33 in the region of the imaginary dividing plane 26. The end faces 24 formed by the end parts 38 of the side legs 34 extend congruently with the imaginary dividing plane 26 extending perpendicular to the axis of symmetry 27 and constitute the contact point for the bottom part 4 arranged underneath. The bottom part 4 with the height 23 and the wall thickness 29 forms an approximately U-shaped cross section 42 with the external dimension 44, the side legs 43 of which taper in the direction of the dividing plane 26 to the external dimension 62, resulting in a smooth transition without a hollow throat 39 between the top part 3 and the bottom part 4 if the wall thicknesses 28 and 29 are the same, for example. The intermediate parts 63 formed by the side legs 43 in the direction of the dividing plane 26 extend towards one another at an angle and terminate with their end faces 25 positioned perpendicular to the axis of symmetry 27 at an end part 64 disposed parallel with the axis of symmetry 27.

Naturally, the top part 3 and/or the bottom part 4 could have the same and/or different wall thicknesses 28 and 29, in which case the external face 40 and/or the internal face 41 would protrude in the region of the imaginary dividing plane 26.

FIG. 7 illustrates another embodiment of the steering column tube 1, made in two parts and consisting of the top part 3 provided with the cutout 2 and the oppositely lying bottom part 4. The top part 3 with the height 22 has a cross section 65 of a substantially trapezoid shape, a width dimension 32 on the top edge 31 of the surface 17 being smaller than a width dimension 66 disposed parallel with the width dimension 32. The parts of side legs 67 between the top edge 31 of the top part 3 and the imaginary dividing plane 26 are arranged at an angle relative to one another in the direction of the height 22 and widen the greater the distance from the base 21 at an angle 35 as far as the end parts 68 with the width dimension 66 disposed parallel with the axis of symmetry 27.

The end faces 24 formed by the end parts 68 of the top part 3 form an imaginary dividing plane 26 extending parallel with the surface 17, on which the perpendicular axis of symmetry 27 stands. The parts of side legs 70 between a base 69 of the bottom part 4 and the imaginary dividing plane 26 extend parallel with the axis of symmetry 27 in the direction of the height 23 at an initial part 71 and terminate at a slightly tapering intermediate part 72 followed by two subsequent end parts 73 parallel with the axis of symmetry 27.

The wall thickness 28 and 29 formed by the top part 3 and the bottom part 4 result in a protrusion at the external face 40 and/or the internal face 41 in the region of the imaginary dividing plane 26. The wall thickness 29 may be smaller than and/or the same as and/or bigger than the wall thickness 28 of the top part 3. Accordingly, the wall thickness 29 could also vary. As illustrated in FIG. 7, if the wall thicknesses 28 or 29 are different. a hollow throat 39 or seam point is formed, which facilitates the task of assembly. If the wall thickness 28 of the top part 3, weakened by the cutout 2, is selected accordingly, the reinforcing strip 20 will no longer be necessary.

FIGS. 8 and 9 illustrate another embodiment of the steering column tube 1. The closed, singlepart profiled steering column tube 1 with the reinforcing strip 20 arranged underneath the cutout 2 and the flanges 58 for receiving the damping elements 61 has a constant wall thickness 74 across the entire circumference. The design and mounting of the reinforcing strip 20 was described in detail with reference to the preceding drawings.

The steering column tube 1 with a height 75 has a cross section 76 that is substantially U-shaped or trapezoidal in shape, a width dimension 32 at a top edge 31 of the surface 17 being smaller than an external dimension 77 arranged parallel with the width dimension 32. The parts of side legs 78 between the top edge 31 and the base 69 are inclined towards one another in the direction of the height 75 and widen with an increasing distance from the base 21 at an angle 35 as far as two end parts 79 having the external dimension 77 disposed parallel with the axis of symmetry 27.

The seamless, tubular bearing receiving points 7 and 8 formed on the two oppositely lying end-side end faces 5 and 6 may be made integrally with the steering column tube 1, the upstanding flanges 80 thereof being bent in a shaping process, in particular by bending and pressing, so as to stand perpendicular to the axis of symmetry 27. Alternatively, the deep-drawn bearing receiving points 7 and 8 may also be joined to the end faces 5, 6 by a joining element. Producing the steering column tube 1 as an integral part significantly simplifies the task of mounting, thereby reducing manufacturing costs in the broader sense.

FIG. 10 illustrates another embodiment of the steering column tube 1. The steering column tube 1 consists of the top part 3 and the bottom part 4 and is designed so that the bottom part 4 has a cutout 81 and the top part 3 with two flanges 82 for mounting the damping elements 61 (not illustrated in FIG. 10) is mounted on top of it.

The top part 3 with the height 22 and the cutout 2 has a cross section 65 that is substantially U-shaped or trapezoid in shape, a width dimension 32 at a top edge 31 of the surface 17 being smaller than an external dimension 83 disposed parallel with the width dimension 32. The parts of the side legs 67 between the top edge 31 and the end faces 24 are disposed at an incline towards one another in the direction of the height 22 and widen with an increasing distance from the base 21 at an angle 35 as far as an end part 68 having the external dimension 83 disposed parallel with the axis of symmetry 327. The bottom part 4, made as a tubular, seamless, in particular drawn or rolled part, having an internal diameter 84 and an external diameter 85, is provided with the cutout 81 extending parallel with the steering shaft mid-line 16 (see FIG. 3). By preference, the external dimension 83 extends at a tangent to the internal diameter 84. The top part 3 is joined to the bottom part 4 at a hollow throat 86 by means of a joining element, in particular being welded, bonded, etc..

FIG. 11 illustrates another embodiment of the steering column tube 1, made in two parts and consisting of the top part 3 with the cutout 2 and the rectangular, strip-shaped individual part 87 disposed underneath. The top part 3 comprises the side legs 78 and the reinforcing strip 20 with flanges 58 for receiving the damping elements 61 (not illustrated) arranged underneath the cutout 2 on the base 21. The top part 3 with the height 75 has a cross section 76 that is substantially U-shaped or trapezoid in shape, the width dimension 32 formed at the top edge 31 of the surface 17 being smaller than the external dimension 77 disposed parallel with the width dimension 32. The parts of the side leg 78 between the top edge 31 and the individual part 87 are arranged at an angle to one another in the direction of the height 75 and widen with an increasing distance from the base 21 at an angle 35 as far as the intermediate parts 79 with the external dimension 77 arranged parallel with the axis of symmetry 27, adjoined by a tapering end part 88. The taper of the end part 88 creates a hollow throat 89, which is an advantage in terms of making the join between the top part 3 and the individual part 87, since it significantly simplifies the assembly process. A wall thickness 90 of the individual part 87 is thinner than or the same as or thicker than the wall thickness 74 of the side leg 78.

FIGS. 12 to 14 illustrate another embodiment of the steering column tube 1, consisting of a shaped body 91 and a rectangular strip 92 mounted on the bottom edge 21. The parts of the side leg 94 disposed between a top face 93 parallel with a steering shaft mid-line 16 (see FIG. 3) and the base 69 are arranged at an incline to one another in the direction of the height 95 and widen with an increasing distance from the top face 93 at an angle 35 and terminate at an intermediate part 96 disposed parallel with the axis of symmetry 27, after which is a semicircular end part 97 with an internal diameter 98 and an external diameter 99. Extending on the top face 93 of the steering column tube 11 is an opening slit 100 having a constant width 101 and a length 102, parallel with the steering shaft mid-line 16. The strip 92 disposed parallel with the steering shaft mid-line 16 and directly underneath the opening slit 100, having a width 103 and a length 104 corresponding to the length 102, is provided with a recess 50 of a width 51 and a length 52. The width 103 of the strip 92 therefore projects beyond the width 101 of the orifice slit 100 formed by the shaped body 91. The opening slit 100 with the width 101 provides ready accessibility for assembly work. The strip 92 extending across the entire length 104 of the steering column tube 1 has flanges 107 with a height 108 arranged perpendicular to the two oppositely lying end-side end faces 105 and 106, which constitute the contact point between the bearing receiving points 7 and 8 and the shaped body 91 joined to the strip 92. The perpendicular flanges 58 with the bore 59 and the diameter 60 at a distance 109 from and parallel with the oppositely lying end-side flanges 107 are used to receive the damping elements 61 (not illustrated). The end faces 110 of the shaped body 91 directed towards one another and spaced apart by the width 101 are arranged parallel with the axis of symmetry 27 and form a hollow throat 111.

The strip 92 may be an integral, square cut part, the flanges 58 and 107 being produced by means of a shaping process, in particular bending, pressing, etc.. Naturally, the flanges 58 and 107 could also be provided in the form of a joined square cut part, for example by bonding, riveting, screwing, welding, in particular by laser welding.

FIG. 15 illustrates a variant of the bearing receiving point 112 formed by the steering column tube 1 comprising the top and bottom part 3, 4. A bearing receiving point 112 forming the bearing unit 113 is provided on the two oppositely lying end-side end faces 5 and 6, consisting of an outer ring 114, a cage 115 and the anti-friction element 116 disposed in the cage 115 and an inner ring 117. The outer ring 114 is mounted directly on the end face 5 and 6, its external diameter 118 projecting at least partially beyond the top part 3 and the bottom part 4, and is joined by means of a joining element 119, for example screws, adhesive, rivets, welding, in particular laser welding, to the parts 3, 4 disposed one above the other. This feature is distinctive because it makes for considerable improvements in terms of complying with tolerance limits, since one part and hence several of the associated work processes can be dispensed with, thereby reducing manufacturing costs.

This part obtains its hardness from the partial hardening in the working region of the antifriction element 117, thereby increasing service life, and a zone of soft, low-carbon material outside of the working region makes it possible to use a technically fault-free welding process, in particular laser welding.

Naturally, it would also be possible to make the bearing receiving points 112 by means of an integral part, for example a deep-drawn part, with the outer ring 114 already integrated, and which is positioned perpendicular to the steering shaft mid-line 16 in a subsequent shaping process, for example bending, pressing, etc.. To this end, the material used will be one which is sufficiently tough for the shaping process, in particular deep-drawing, stretch-forming. etc., and has a low carbon content for the welding process and which will also be hardened in a subsequent work process, etc..

In all of the embodiments and as illustrated in FIG. 3, it is also possible to provide the end-side end face 5 or 6 directed towards the driver's cab with a sleeve 120 made from plastics, metal, etc., for receiving fittings, in particular indicator fittings, windscreen wiper fittings, etc., not illustrated.

In each of the embodiments described, another possible option is to join at least one of the seamless bearing receiving points 7 and/or 8 to the steering column tube 1 and/or to join the top part 3 to the bottom part 4 and/or to join the reinforcing strip 20 to at least one of these two parts 3 or 4 by riveting and/or pressing and/or bonding and/or soldering and/or welding, for example, in particular by laser welding, since laser welding or soldering are methods which require only a minimum of local heat to be applied, thereby avoiding any further deviation from tolerances. Naturally, any other known or recently developed joining elements used in the prior art may be employed for producing a join.

As may be seen from FIG. 3, the steering column tube 1 has several slits 121 and bores 122, which can be used for positioning and centring in the welding device, bending device, etc.. A seamless bearing receiving point 7 or 8 directed towards the driver's cab with the integrated bearing 9 or 10 has a coil spring 123 adapted to the cage, by means of which manufacturing tolerances can be compensated in the axial direction whilst simultaneously imparting a slight pre-tensioning to the steering shaft 15 between the two bearing receiving points 7 and 8.

Manufacturing and assembly method:

An optionally rectangular and/or planar cut piece is made into a multi-cornered section forming the top part 3 and the bottom part 4 by a process of bending or a process of edge-shaping in a plane perpendicular to the longitudinal extension of the cut piece. Using the bores 18, 19 provided on the base 21 of the top part 3, the reinforcing strip 20 made from a cut and bent piece and disposed underneath can be mounted by and expediently welded to produce a laser welded joint. In order to secure accurate positioning and centring during assembly and production work, several bores 122 and slits 121 are provided on the top part 3 and the bottom part 4. The position of the top and bottom parts 3 and 4 predetermined by the welding device enables accurate relative positioning without any significant deviation from tolerances, so that the oppositely lying faces of the side legs 34 formed by the top part 3 and the side legs 43 formed by the bottom part 4 constituting the base 21 and 69 form an end face 24, 25 plane-parallel with the dividing plane 26, which will serve as the joining point, in particular for the laser welding process.

Once the reinforcing strip 20 has been welded, preferably onto the base 21 underneath the cutout 2 of the top part 3, the top part 3 can be joined to the bottom part 4 at the joining seam to produce the steering column tube 1, on which the two oppositely lying end faces 5, 6 are adapted to form two bearing receiving points 7, 8, which are made integrally with the top part 3 as a deep-drawn part and then bent so as to be aligned perpendicular to a steering shaft midline 16 of the steering shaft 15 and joined to the top part 3. The bearing receiving points 7, 8 may naturally also be vertically positioned on a supporting plate as separate turned parts, drawn or rolled parts, in turn joined to the end face 5, 6.

In the next assembly step, a bearing 9 having a coil spring 123 known from the prior art is pressed into a bearing receiving point 7 closer to the steering wheel with, into which a steering shaft 15, also known per se, is pushed so that the steering shaft 15 is mounted as the bearing 10 is subsequently pressed into the bearing receiving point 8. Any axial clearance of the steering shaft 15 in the direction of longitudinal extension is compensated by pressing a fixing element, not illustrated in the drawings, onto the coil spring 123.

In another embodiment, as described above, the bearing receiving point 7, 8 is already pre-fabricated on the steering column tube 1 comprising an outer ring 114 made as a deep-drawn part or as a separate component for a ball bearing which will be used by preference. The pre-mounted, greased ball bearing will be welded on as one of the last work processes and hence with the steering shaft 15 already mounted, so that the construction remains without tension and all tolerances can be compensated. The total tolerances and manufacturing inaccuracies which occur in the components during manufacture are therefore irrelevant.

FIGS. 16 to 19, which will be described together, illustrate a partial perspective view of other embodiments of a bearing box 124 with a different embodiment of a steering column tube 125. The steering column tube 125, expediently made from several parts, has at least two half-shell-shaped parts 127, 128 joined by ajoining element in joining regions 126. Mutually abutting longitudinal end faces 129, 130 form the joining region 126, extending in a plane flush with a perpendicular longitudinal mid-plane of the bearing box 124. The steering column tube 125 and its mutually opposing parts 127, 128 to be connected transversely to the longitudinal direction has and have a multi-cornered cross section between bearing receiving regions 131, 132 at their distal ends 133, 134 for bearing elements that will be described in more detail below. The bearing receiving regions 133, 134 forming the receiving points 135, 136 are integrally formed on the distal end regions 131, 132, each of the half-shell-shaped parts 127, 128 forming a substantially semicircular bearing part 137. The abutting longitudinal end faces 129, 130 of the parts 127, 128 abutting in the joining region 125 are joined to one another by means of the joining element.

Two or more bearing parts 137 joined to one another to form a circular bearing receiving point 135, 136 each have an individual recess in the material 138 in the joining region 126. The substantially U-shaped material recess 138 extending across a part of a width of the bearing receiving point 135, 136 in the longitudinal direction of the bearing box 124 primarily ensures that the degree of shaping does not lead to any inadmissible deformation of the longitudinal end faces 129, 130 in the joining region 125 as the join is being made, thereby enabling the bearing receiving points 135, 136 to be made to a higher degree of accuracy.

One of the two trapezoid-shaped, shell-shaped parts 127; 128 has a cutout 139 co-operating with a fixing mechanism extending parallel with the longitudinal mid-axis 16 of the steering shaft 15. A part region of side leg 140 in a plane extending parallel with the vertical longitudinal mid-plane has several edges in order to avoid any weakening in the stiffness which might otherwise arise by providing the slit-shaped cutout 139, so that parts of the side leg 140 are fitted in an overlapping position in at least certain regions in a stiffening region 141. As may be seen in FIGS. 16 to 18, the steering column tube 125 of the bearing box 124 is provided with mounting flanges 142 for fixing built-on components, not illustrated, which are integrally formed on the steering column tube 125 and which, for practical purposes, are aligned in a plane extending parallel with the vertical longitudinal mid-plane perpendicular to the horizontally aligned longitudinal mid-plane. Adjoining one of the end regions 131; 132 is a respective frame-type support arm 143 formed by the two shell-shaped parts 127, 128 and integrally formed thereon. The vertical longitudinal mid-plane extends through the joining regions 126 formed by the abutting longitudinal end faces 129, 130, so that the vertical longitudinal mid-plane of the support arm 143 extends flush with the vertical longitudinal mid-plane of the steering column tube 125. For practical purposes, the support frame 143 has a multi-cornered cross section in a plane perpendicular to its longitudinal extension. Legs 144 disposed transversely to the longitudinal direction of the support arm 143 extend from support arm parts 145, to be mutually joined, in a flat arrangement to at least one side leg 140 of the parts extending parallel with the vertical longitudinal mid-plane. The support arm parts 145 extending between the legs 144, spaced apart from one another by a width dimension 146, have several edges and essentially form a substantially U-shaped cross-sectional contour in a plane perpendicular to their longitudinal extension.

Arranged on the oppositely lying legs 144 and extending parallel with the longitudinal midaxis 16 and disposed in the same plane is a respective cutout 147. A bolt, not illustrated, which is inserted through the slit-shaped cutout 147 and joined to a retaining mechanism permanently fixed on the bodywork of the vehicle forms a pivot axis, about which the bearing box 124 receiving the steering shaft 15 is mounted so that it can pivot in a radial direction to its longitudinal extension.

One of the shell-shaped parts 127; 128 is formed from a flat cut and/or punched and/or bent part 148—as illustrated in FIG. 17. It comprises two part regions forming the steering column tube 125 with the bearing receiving points 135, 136 and the support arm part 145. The single-piece cut and/or punched and/or bent part 148 is provided with cutouts 139, 147 extending parallel with the longitudinal mid-axis 16 in the longitudinal direction and, after cutting and/or punching, is folded by means of a shaping process, such as edging, pressing, etc., along its bending lines 149—indicated by broken lines. The bending lines 149 used for forming the steering column tube 125 and the support arm part 145 preferably extend parallel with the longitudinal mid-axis 16, whereas the bending lines 149 for forming the bearing receiving points 135, 136 extend perpendicular to the longitudinal mid-axis 16. In order to stiffen a transition region 150 between the steering column tube 125 and the support arm 143, flat stiffening elements 151 are provided between them. The cut and/or punched and/or bent part 148 is expediently of identical wall thickness along the entire length and/or width, which is between 1 mm and 5 mm, in particular between 1.5 and 3.5 mm, for example 2 mm.

Naturally, it would also be possible, as illustrated in FIG. 18, for the frame-shaped support arm 143 and the support arm parts 145 forming it to be joined to the steering column tube 125 in a positive and/or force-fit arrangement by means of a joining element 152. The support arm 143 may naturally also be made from a single-piece cut and/or punched and/or bent part 148.

The steering column tube 125 illustrated in FIG. 19 is made up of two symmetrical shell-shaped parts 127, 128 as viewed head-on. The parts of side leg 140 between a base 153 and an apex 154 of the first part 127 are arranged at an incline to one another in the direction of a height 155 and widen with an increasing distance from the apex 154—at an angle 156, 157—as far an intermediate part 159 having the width dimension 146 arranged parallel with an axis of symmetry 158. Although not illustrated, it would also be possible to provide a widened and/or tapered region on this adjoining region in order to enhance strength. Adjoining it is an end part 160 extending parallel with the longitudinal mid-axis 16 and forming the base 153, the end-side longitudinal end face 129 of which extends congruently with the axis of symmetry 158. In the region of the apex 154, an inclined part of the side leg 140 forms the longitudinal end face 129 extending congruently or flush with the axis of symmetry 158. The cutout 139 extending parallel with the longitudinal mid-axis 16 is expediently arranged in the intermediate part 159 of the first part 127.

The other part 128 lying opposite the first part 127 has parts of side leg which extend at an incline to one another between the apex 154 and the base 153 in the direction of the height 155, which extend at an increasing distance from the apex 154—at angles 156, 157—as far as the subsequent intermediate part 159 disposed parallel with the axis of symmetry 158. It is adjoined by the end part 160 forming the base 153, arranged after it and extending perpendicular to the axis of symmetry 158. The longitudinal end faces 130 of the end part 160 and the part of the side leg 140 in the region of the apex 154 of the part 128 abut flat with one another at the longitudinal end faces 129 of the oppositely lying first part 127 and are joined to one another in the resultant joining region 126 by means of a positive and/or force-fit joining element. The first part 127 and the other part 128 are expediently of an identical wall thickness 161 across the entire cross section. A part region is shaped, expediently the oppositely lying end regions 131, 132 of the parts 127, 128 having a multi-cornered cross section, to form a semicircular bearing part 137.

FIG. 20 provides a perspective view of another embodiment of a bearing box 124. It comprises the steering column tube 125 with the receiving regions 133, 134 and the bearing receiving points 135, 136 forming them as well as the support arm parts 145 forming a support arm 143 with the shell-shaped parts 127, 128 integrally formed thereon, and a flat bearing plate 162. The symmetrically designed parts 127, 128 have parts of side legs which extend at a mutual incline between the apex 154 and the projecting end part 160 in the direction of the height 155 which widen at increasing distance from the apex 154—at an angle 156—as far as the end part 160 disposed parallel with the axis of symmetry 158. The longitudinal end faces 130 of the end part 160 and the part of the side leg 140 in the region of the apex 154 of the part 128 sit abutting flat with one another at the longitudinal end faces 129 of the oppositely lying first part 127 and are joined to one another by means of a positive and/or force-fit joining element in the resultant joining region 126. The bearing plate 162 forming the bearing receiving points 135, 136 is made from a strip-shaped cut and/or punched and/or bent part, the bearing receiving points 135, 136 being made first of all. These are then folded back in an axis extending perpendicular to the longitudinal axis. The bearing plate 162 extending across the length and across the width dimension 146 is joined in a force-fit and/or positive-fit arrangement by its oppositely lying mutually parallel end faces extending parallel with the longitudinal mid-axis 16 to the side legs 140. The bearing receiving points 135, 136 forming the receiving regions 133, 134 are formed by seamless, closed bearing rings. For practical purposes, the strip-shaped bearing plate 162 has a thicker wall thickness than the parts 127, 128 of the steering column tube 125 and the support arm parts 145. A width of the bearing plate 162 is at least slightly smaller than a width dimension 146 between the oppositely lying end parts 160 of the side leg 140. The parts 127, 128 are joined to the bearing plate 162, at least in certain regions, by means of a joining element.

The slit-shaped cutouts 147 provided in the support arm parts 145 extend respectively parallel with one another and parallel with the longitudinal mid-axis 16 and parallel with the cutout 139 provided in the part 127.

FIG. 21 illustrates another embodiment of the bearing box 124, consisting of the support arm 143 and the steering column tube 125. The single-piece steering column tube 125 is provided in the form of a shaped tube 163 with a circular cross section. Arranged at one of the end regions 132 is the one or multi-part support arm 143, which is joined to the steering column tube 125 by a joining element 152. A bearing plate 164 having a substantially U-shaped cross section encloses the circular steering column tube 125, at least in certain regions, and is provided with the cutout 139 extending parallel with the cutout 147 of the support arm 143 at least in a support plate leg 165. The support plate 164 is in turn joined to the steering column tube 125 at least in certain regions, by means of a joining element 152. For practical purposes, the cutout 139 lies in a plane disposed underneath the steering column tube 125, so that components can be provided for a fixing device, not illustrated, externally to the steering column tube 125.

FIGS. 22 to 25, which will be described together, illustrate different views of a bearing box 124 for mounting the steering shaft 15. The steering column tube 125 at least partially enclosing the steering shaft 15 is provided with bearing elements 166, 167 at its distal end regions 131, 132, by means of which the steering shaft 15 is mounted so as to move in a rotating motion and in an axial direction of the steering shaft 15 and is retained substantially without any clearance in the direction disposed radially thereto. It should be pointed out that the embodiments of the steering column tube 1 illustrated as examples in FIGS. 1 to 15 may, but need not necessarily, be used with the bearing box 124. The bearing box 124 may naturally be provided with all single or multi-part steering column tubes 1; 125 known from the prior art. As illustrated in the embodiment shown as an example here, the steering shaft 15 provided in the form of a hollow shaft has several steering shaft portions 168, 169 with different cross sections, one of which steering shaft portions 168 has a circular cross section extending concentrically about a longitudinal mid-axis 16 of the steering shaft 15 and the steering shaft portion 169 arranged immediately adjacent to this steering shaft portion 168 in a plane perpendicular to its longitudinal extension has a cross section of a more or less clover-leafed shape. The first steering shaft portion 168 has a cross-sectional taper in its longitudinal contour, in particular a tapering external and internal diameter, so that a shoulder 173 is formed by the gradation between the tapering external diameter 170 and internal diameter 171 to form a bearing point 172. The external diameter 170 of the first steering shaft portion 168 bounds an external dimension 174 of the other steering shaft portion 169 with the cross section of a substantially clover-leafed shape. Another bearing point 175 for the bearing element 167 is provided in the longitudinal contour of the other steering shaft portion 169.

As illustrated, the steering column tube 125 of this embodiment is provided with receiving regions 176 at the distal end regions 131, 132, in particular bearing receiving points 177, for the bearing element 166, 167, which are formed by folding and stretch-forming and/or punching and/or deep-drawing, integral with the steering column tube 125.

Intermediate regions 178 tapering conically in the direction remote from the end faces 5, 6 are bounded in the longitudinal direction thereof by arcuate segments forming receiving segments 180 spaced concentrically apart from one another by slits 179 around the longitudinal mid-axis 16. The receiving segments 180 mutually separated by diametrically opposed slits 179 around the circumference form the receiving regions 176 having an external diameter 181, in particular the bearing receiving points 177. The bearing elements 166, 167 mounting the steering shaft 15 so that it can turn in a rotating motion relative to the steering column tube 125 have at least two bearing parts 183, 184 which are displaceable relative to one another by means of at least one intermediate part 182, in particular an anti-friction element, one of which bearing parts 183 co-operates with the oppositely lying receiving regions 176, and the steering column tube 125 and the bearing elements 166, 167 are joined in a relative position to one another by means of at least one form-fit and/or positive-fit joining element 185 in overlap regions 186 forming the receiving regions 176 on the steering column tube 125 and the bearing parts 183.

The other bearing part 184 adapted to the cross-sectional shape of the steering shaft 15 and the steering shaft portions 168, 169, is optionally connected by the joining element 185 to the steering shaft 15 by a positive-fit and/or force-fit arrangement. The joining element 185 may be a weld seam, for example, preferably a laser or plasma welded seam, a layer of adhesive or a soldered joint. The laser or plasma welding may be effected with or without an additional material, preferably without. The substantially shell- or dish-shaped bearing elements 183, 184 forming an outer ring 187 and inner ring 188 are expediently made from a flat cut part by a deep-drawing or stretch-forming process and/or a punching process. Naturally, the bearing parts 183, 184 may also be made by any other cutting process.

The bearing elements 166, 167 spaced at a distance apart from one another in the longitudinal direction of the steering shaft 15, received by the oppositely lying receiving regions 176 or directly on the steering column tube 125, are spaced apart from one another by an adjustable or variable longitudinal distance 189. At least one of the bearing elements 166 is held in position and fixed once the position has been fixed relative to the steering column tube 125 and/or the steering shaft 15 and/or the other bearing element 167, after which the other bearing element 167 is pushed in order to make an adjustment in the direction parallel with the longitudinal mid-axis 16. Once a pre-set position is reached, this bearing element 167 is also fixed in position relative to the steering column tube 1 and/or the steering shaft 15. To this end, the outer ring 187 co-operating with the receiving region 176 is expediently designed so as to be longitudinally slidable, the inner ring 188 being moved with it by the same distance.

The bearing elements 166, 167, in particular the bearing parts 183, are moved into a position overlapping with receiving regions 176 in the assembled state. The inner ring 188 may be supported on the arcuately shaped curved shoulder 173 and the bearing point 172 forming it if necessary, after which the position of the outer ring 183 is adjusted on and relative to the steering column tube 125. Once the predeterminable longitudinal distance 189 measured parallel with the longitudinal mid-axis 16 between the bearing elements 166, 167 is adjusted, at least one of the bearing parts 183, 184, for practical purposes both bearing parts 183, 184, are positioned and joined by means of the joining element 185, for example to the receiving regions 176 and/or the steering shaft 15. The joining element 185 is preferably provided in the from of a weld seam, in particular laser or plasma welded seam, in which case the join may be made with or without additional material. In view of the fact that it is possible to adjust at least one of the bearing elements 166, 167 and to vary the longitudinal distance 189 associated with them, it is possible to pre-tension the steering shaft 15, at least at certain points, in the region between the bearing points 172 and 175 and in this manner set a predeterminable rolling friction between the steering shaft 15 and the bearing elements 166, 167 and compensate for any clearance in the direction of the longitudinal extension of the steering shaft 15. Consequently, components which serve as means of generating an active pre-tensioning force in the longitudinal extension of the steering shaft 15 can be dispensed with, thereby reducing the manufacturing complexity. It should be pointed out that the pre-tensioning force or the rolling friction is determined so that the steering shaft 15 mounted between the bearing points 166, 167 is not susceptible to any deflection extending in the direction perpendicular to the longitudinal mid-axis 16 and does not cause any friction-induced wear on the bearing elements 166, 167.

As a result of this extra option of adjusting at least one of the bearing elements 166, 167, in particular at least one of the bearing elements 183; 184, the steering shaft 15 can be designed so its relative position can be adjusted in the longitudinal direction relative to the steering column tube 125 permanently joined to a bodywork and a predetermined assembled dimension 192 can be set and retained between any point 190 and any measurement marker 191. As indicated, the assembled dimension 192—shown by broken lines—is unambiguously predetermined by means of a longitudinal distance extending between the point 190 on the steering column tube 125 and the measurement marker 191 on the steering shaft 15. The point 190 may be predetermined by means of a another component, not illustrated, to be mounted at this point and the measurement marker 191, for example an end-face end of the steering shaft 15, for example.

As illustrated more clearly in FIG. 25, the bearing element 166; 167 having a bearing part width 194 disposed on the receiving region 176 is bounded by a base plate 196 provided with a cut in the material 195.

A peripheral land 197 formed by the material cut 195 in the base plate 196 is expediently aligned perpendicular to the outer ring 187 forming a hollow cylindrical casing 198, across at least a part of the bearing part width 194, in a plane extending perpendicular to the longitudinal extension of the hollow cylindrical casing 198. On an internal face directed towards the intermediate part 182 arranged between the inner ring 188 and the outer ring 187, the outer ring 187, which is made without cutting by a bending or deep-drawing process, has a corresponding bending radius 200 with a diameter 199. The outer ring 187 adjustably disposed on the receiving region 176 of the steering column tube 125 has several part portions extending from the receiving regions 176 in the direction of an end-side end of the steering shaft 15 which assume different functions, one of which part portions is formed by a shoulder part 201 co-operating with the receiving region 176 and the guide part 202 receiving the intermediate parts 182 lying opposite this part portion.

When the inner ring 188 is positioned against the shoulder 173 forming a stop surface, as illustrated, the assembled dimension 192 can be set by adjusting the steering column tube 1; 125 on and relative to the outer ring 183. To this end, the inner ring 188 has a released position so that it is in contact with the shoulder 173 at a tangent only and is supported on the steering shaft 15 by only a part region.

Arranged between the oppositely lying part portion forming the shoulder part 201 and the guide part 202 is an additional adjustment region 203 having the same internal dimensions as the shoulder part 201 and the guide part 202, for example. The shoulder part 201, the guide part 202 and the adjustment region 203 each have a width of from 204 to 206. The sum of the individual widths 204 to 206 constitute the bearing part width 194 of the outer ring 187. It should be pointed out that the bearing part width 194 is essentially the same as the hollow cylindrical casing 198 forming the outer ring 187. Allowance must be made for a wall thickness of the peripheral land 197 when calculating the mounting space for a bearing element 166, 167 of this type. The width 205 of the adjustment region 203 is selected so that a minimum adjustment dimension can be achieved extending in the direction parallel with the longitudinal mid-axis 16 of the steering shaft 15 in order to conform to a specific assembled dimension 192. The width 205 of the adjustment region 203 is between 0.5 mm and 10 mm, for practical purposes between 0.7 mm and 4 mm, for example 0.6 mm. A wall thickness 207 is expediently of a constant dimension across the entire cross section of the outer ring 187 and is between 1 mm and 10 mm, for practical purposes between 2 mm and 6 mm.

Naturally, both the outer ring 187 and the inner ring 188 may be made by a production process involving cutting, such as turning, for example. The shoulder and guide part and adjustment region 201, 202, 203 are each of an identical internal diameter 208, which is at least slightly larger than the maximum external diameter 181 of the receiving region 176. Naturally, the individual internal diameters 208 of the shoulder and guide part and adjustment region 201, 202, 203 may be different. As a result, the outer ring 187 can be pushed onto the receiving region 176. As the outer ring 187 is pushed onto the receiving region 176 on the steering column tube 125, which is of a width 209, the outer ring 187 is guided in the longitudinal direction and in a radial direction. The width 209 of the receiving region 176 consists of a width 210 of a shoulder part 211 and a width 212 of an adjustment region 213. When the steering column tube 125 is in the assembled state, the shoulder part 201 of the outer ring 187 forms the overlap region 186 in conjunction with the shoulder part 211 in the receiving region 176.

If it is necessary to conform to a prescribed assembled dimension 192, for example the longitudinal distance between the steering shaft 15 and the steering column tube 125, the prescribed distance or the assembled dimension 192 can be achieved by a relative displacement of the outer ring 187 on the receiving region 176 and relative to the steering column tube 125, and, once the desired position or relative positioning has been obtained, the adjusted outer ring 187 can be expediently joined in a non-detachable manner to the receiving region 176 of the steering column tube 125 by means of a joining element 185.

Once the assembled dimension 192 has been obtained by adjusting and fixing the outer ring 187 of the first bearing element 166, the other bearing element 167 lying opposite the bearing element 166 is moved in the direction of the first bearing element 166 enabling a clearance-free fit to be obtained, thereby compensating for any tolerance, without the need for any additional clearance-compensating elements.

The bearing part 183 of the bearing element 167 is preferably of the same structural design as the bearing part 183 of the bearing element 166. The other bearing part 184 and the inner ring 188 is adapted in at least certain regions to the cross-sectional shape of the steering shaft 15. A width of the inner ring 188 of the bearing element 167 is made up of several part-sections, one of which part sections, disposed in the region of the intermediate part 182 and the anti-friction element, being formed by a guide part 202 receiving the anti-friction element and concentrically encircling the longitudinal mid-axis 16 of the steering shaft 15. The other part section adjoining this part section is provided with several diametrically opposed strip-shaped projections 214 joined to the steering shaft 15 in a positive-fit arrangement and extending across a part of the circumference. For practical purposes, the projections 214 extend starting from the circular part-section in the direction of an end-side end of the steering shaft 15. These projections 214 engage in an overlapping positive-fit arrangement with the corner regions 215 of the substantially clover-leaf shape of the steering shaft 15 so that when the steering shaft 15 is turned, the inner ring 188 is displaced relative to the stationary outer ring 187 joined to the steering column tube 125. Naturally, the inner ring 188 may additionally be joined to the steering shaft 15 in a form-fit and/or positive-fit arrangement by means of the joining element 185.

At this stage, it should be pointed out that the joining element 185 between the bearing parts 183, 184 and the receiving regions 176 in the overlap region 186 and in the joining region forming them and/or the steering shaft 15 is provided at least at intermittent points or in flat areas or around the entire circumference.

FIGS. 26 and 27, which will be described together, illustrate other embodiments of a bearing box 124 with the steering column tube 125 having a cylindrical cross section, show in longitudinal section. Within the longitudinal extension, for example at its oppositely lying distal end regions 131, 132, the steering column tube 125, which is expediently made in a single piece, is provided with the receiving regions 176, which are directly provided with the shell-shaped bearing part 183 and the outer rings 187 forming them. The outer rings 187 of the bearing elements 166, 167 placed and positioned on the steering column tube 125 at the external surface forming the receiving region 176 are joined directly to the steering column tube 125 by a positive-fit and/or force-fit arrangement, in particular a force-fit arrangement, so as to be prevented from moving. In order to compensate for manufacturing tolerances of the steering column tube 125, another option would be to finish the receiving regions 176 subsequently by cutting processes. The design and layout of the bearing elements 166, 167 and the way in which the assembled dimension 192 and the longitudinal distance 189 are obtained may be found from the detailed description of the drawings given above.

FIG. 27 illustrates the receiving regions 176 formed by cut part-regions on an internal surface or internal face of the steering column tube 125. The outer rings 187 of the bearing elements 166, 167 inserted in and positioned on the steering column tube 125 are directly joined to the steering column tube 125 by a positive-fit and/or force-fit arrangement, in particular a force-fit, so as to be prevented from moving. Starting from the receiving region 176 in the direction of the end-side end of the steering shaft 15, the outer rings 187 co-operating with the receiving regions 176 also have the shoulder part 201, the guide part 202 and the adjustment region 203 (see FIG. 25) in the direction of their bearing part width 194. The shoulder part 201 of the outer ring 187 overlaps with at least a part of the width 209 of the receiving region 176 and is joined to the steering column tube 125 in a positive-fit and/or force-fit arrangement in the resultant overlap region 186. An internal dimension 216, in particular a diameter, is greater by at least the wall thicknesses 207 plus the internal diameter 208 of the outer ring 187 so that at least a part of the bearing element 166, 167 is inserted in the steering column tube 125 (see also FIG. 25).

In another embodiment, not illustrated, the outer ring 187 widens radially, starting from the shoulder part 201, across the bearing part width 194 in the direction of the guide part 202 and the internal diameter 208 in the region of the shoulder part 201 is smaller than the internal diameter 208 in the region of the guide part 202. The adjustment region 203 between the shoulder part 201 and the guide part 202 is of the same dimensions as the shoulder part 201.

Naturally, this embodiment of the arrangement of bearing elements 166, 167 may also be used with the layout of the bearing receiving point 177 in which the outer ring 187 is inserted in the bearing receiving point 177.

FIG. 28 illustrates an embodiment of the bearing box 124 which may be construed as an independent solution proposed by the invention in its own right.

The steering column tube 125 of the bearing box 124 forms, in the longitudinal extension, in particular in one of the end regions 131; 132, one of the bearing parts 183, 184 of the bearing element 166; 167. The steering column tube 125, the cross section of which is preferably cylindrical in a plane perpendicular to its longitudinal extension, is of a pot-type design and the end region 132 is provided with a split in the material 217 in which the steering shaft 15 and inner ring 188 are inserted. The steering column tube 125 may be made from a drawn and/or deep-drawn and/or form-stretched and/or punched part of metal material. Naturally, it would also be possible for the steering column tube 125 to be made from a wear-resistant plastics. A guide part 220 for at least one intermediate part 182 or anti-friction element, disposed between a radial peripheral land 218 extending around the end-face end region 132 of the steering column tube 1 and a hollow cylindrical casing 219 forming the steering column tube 125, has a radius 221 corresponding to the diameter 199 of the anti-friction element. The bearing element 166 in the oppositely lying end region 131 is of the same design as that described with reference to the other embodiments.

In order to position the steering shaft 15 relative to the steering column tube 125, the steering shaft 15 and the inner ring 188 are placed in an intended position and once this position is reached, the inner ring 188 is joined to the steering shaft 15 in a positive-fit and/or force-fit arrangement by means of the joining element 185.

In another embodiment, not illustrated, the steering column tube 125 is radially widened in the end region 131; 132 and the transition region between a smaller and a larger cross-sectional dimension forms the guide part 202 for the intermediate parts 182. Consequently, at one end region 132, the steering column tube 125 forms the pot-type bearing part 183 with a material split 217 and the bearing part 183 at the other end region 132 is formed by a material widening.

FIG. 29 illustrates another embodiment of a bearing box 124 with a different embodiment of a bearing receiving point 222. At least one bearing receiving point 222 is disposed on one of the end faces 5; 6 forming the oppositely lying receiving region 176, in which the bearing part 183 and the outer ring 187 can be joined to the steering column tube 125 by means of a positive-fit and/or force-fit connection, in particular a force-fit connection, by means of the joining element 185. The bearing receiving point 222 is of a substantially pot-shaped design and is provided with the material split 195. The guide part 201 for the intermediate parts 182 is formed between the remaining peripheral land 197 and the hollow cylindrical casing 198 forming the bearing receiving point 222. The inner ring 188 projects in the direction of the end-side end of the steering shaft 15 beyond the outer ring 187 and is also joined to the steering shaft 15 in a positive-fit and/or force-fit connection by means of the joining element 185.

FIGS. 30 to 37, which will be described together, are highly simplified, schematic diagrams illustrating other embodiments which may be used for the receiving region 176 on the steering column tube 125 and for the bearing element 166; 167. FIG. 30 illustrates the bearing part 183 co-operating with the receiving region 176, which is of a pot-shaped design, and the shoulder part 201 co-operating with the receiving region 176, the guide part 202 lying opposite it and the adjustment region 203 arranged between, each being of an identical internal diameter 208. The receiving region 176 is preferably cylindrical. Once the outer ring 187 has been adjusted on and relative to the steering column tube 125 and a predetermined assembled dimension 192 has been achieved, it is non-detachably joined to the steering column tube 125 and the receiving region 176 by means of the joining element 185, which in the embodiment illustrated as an example here is provided in the form of a fillet joint. Naturally, it would also be possible for one of the parts, in particular the outer ring 187, to be welded in the overlap region 186. As illustrated in this embodiment, the steering column tube 125 is dimensioned so that its external diameter 181 is smaller at least by the wall thickness 207 of the outer ring 187, so that the external dimensions of the steering column tube 125 on the bearing element do not project beyond the bearing element 66.

FIG. 31 illustrates the steering column tube 125, which forms the receiving region 176 on its internal face. This embodiment is particularly suitable for welding the steering column tube 125 in the overlap region 186. The internal diameter 208 of the bearing part 183 differs across its longitudinal extension so that the internal diameter 208 of the shoulder part 201 and the adjustment region 203 are of identical design and the internal diameter 208 in the region of the guide part 202, stating from the shoulder part 201, becomes wider in the direction of the guide part 202. Adjoining this is the peripheral land 197 extending in the direction of the steering shaft 15 and forming a region of the guide part 202.

FIG. 32 illustrates another embodiment with the bearing part 183 arranged on the external face of the steering column tube 125 and receiving region 176, the internal diameter 208 of the shoulder part 201 and the adjustment region 203 being of identical dimensions. In the remaining longitudinal extension of the bearing part 183, the internal diameter 208 tapers, so that part regions of the guide part 202 extend cylindrically and then become wider. The internal diameter 208 of a guide part abutment surface 223 in the region of the intermediate part 182 is in turn expediently of identical dimensions to the internal diameter 208 of the shoulder part 201 and the adjustment region 203. Between the adjustment region 203 and the guide part 202, the bearing part 183 has a curving concave contour directed towards the steering shaft 15. In the axial direction of the steering shaft 15, the bearing element 166; 167 is secured to the steering shaft 15 by means of securing elements, not illustrated, such as clamping elements for example, provided on the steering shaft, or positive and/or force fitting components additionally mounted on the steering shaft 15. For practical purposes, an external dimension of the bearing element 166; 167 is bounded by the external dimension of the steering column tube 125.

FIG. 33 illustrates another embodiment of the design of the bearing part 166; 167, disposed on the internal face of the steering column tube 125. In the direction of its longitudinal extension, the bearing part 166; 167 is cylindrical in the region of the shoulder part 201 and the adjustment region 203, and has an external dimension 224, in effect a diameter, which is at least slightly smaller than an internal dimension 216 of the steering column tube 125. The guide part 202 lying opposite the shoulder part 201 and widening in the direction of the longitudinal extension of the bearing part 183; 184 forms the guide part abutment surface 223 for the intermediate part 182.

As may be seen more clearly from FIGS. 36 and 37, other embodiments for the design of the bearing part 183; 184 and the receiving region 176 on the steering column tube 125 are illustrated. The steering column tube 125 preferably has the receiving region 225 at one of its end regions 131; 132. which is integrally formed on the steering column tube 125. The one-part or multi-part steering column tube 125 may have a circular and/or multi-cornered cross section. In the preferred embodiment, as illustrated, the steering column tube 125 is polygonal and the receiving region 225 is formed by several diametrically opposed receiving segments 228 separated from one another by receiving compartments 226 for bearing parts 183; 184 provided with matching projections 227. The receiving segments 228 are preferably of the same wall thickness as the parts 127, 128 forming the steering column tube 125. The internal dimension 216, in particular the diameter, of the bearing part 166; 167 bounds the radii of curvature of the substantially arcuate receiving segments 228 to be shaped. The slit-shaped receiving compartments 226 extending in the longitudinal direction of the steering column tube 125 project between the receiving segments 228 having an arc length 229, at least across a part of a length of the receiving segments 228, so that longitudinal side faces 230 of the radially spaced receiving segments 228 directed towards one another serve as connecting surfaces for the projection 227 of the bearing part 183 projecting into the receiving compartments 226. Optionally, the side face extending between the oppositely lying longitudinal side faces 230 may also serve as a connecting surface.

The bearing part 183 is illustrated in more detail in FIG. 36. The projections 227 of the bearing part 166; 167 complementing the receiving compartments 226 of the receiving region 225 have the shoulder part 201 and the adjustment region 203 directed towards the steering column tube 125, adjoined by the guide part 202 forming the radially extending peripheral land 218. For practical purposes, a parallel length of the receiving compartments 226 measured parallel with the longitudinal axis 16 of the steering shaft 15 is longer than a length of the projections 227 of the bearing part 183; 184. At least one of the wall thicknesses of the receiving segments 228 or the bearing part 183; 184 is expediently of a smaller dimension. Naturally, it would also be possible for the two wall thicknesses 207 to be of identical dimensions or wall thicknesses.

At least one of the bearing parts 183; 184 received between the receiving segments 228 so that it is prevented from turning is designed so that it can be displaced relative to the steering column tube 125, in order to set and comply with the mounted assembled dimension 192. Once the bearing part 183; 184 has been positioned relative to the steering column tube 125 or the steering column tube 125 has been positioned relative to the bearing part 183; 184, the latter are non-detachably joined to one another by means of the joining element 185 in the linear overlap region formed by the longitudinal side faces 230 of the projections 227 and the longitudinal side faces 230 of the receiving segments 228.The external diameter 181, 224 of the receiving regions 225, in particular the receiving segments 228 and the bearing part 183; 184 extend flush with one another. For practical purposes, the longitudinal side faces 229, 230 of the receiving segments 228 and projections 227 abutting with one another to form the connection surfaces are joined to one another by means of a fillet joint.

The joining region 126 expediently lies between the two oppositely lying parts 127, 128 of the steering column tube 125 and between the oppositely lying receiving segments 228 formed by each of the parts 127, 128. For practical purposes, the parts 127, 128 are of a symmetrical design. The vertical longitudinal mid-plane preferably extends congruently with the plane formed between the joining regions 126.

Independently of the descriptions given above relating to the drawings, it should be pointed out that the dimensions, such as the internal diameter 208 or the external dimension 224 of the bearing part 183 and the dimensions such as the internal dimension or external diameter 216; 181 of the receiving region 133; 134; 176; 225, are selected so that the bearing part 183 is pushed against the action of a friction force acting between the bearing part 183 and receiving region 133; 134; 176; 225 during the assembly process.

The different embodiments of the bearing parts 183 and the outer ring 187 on the bearing box 124 described with reference to the drawings may naturally be used in any combination with one another.

Finally, for the sake of good order, it should be pointed out that in order to provide a clearer understanding of the steering column tube 1; 125 and the bearing box 124 and their constituent parts, the illustrations are to a certain extent not to scale and/or shown on an enlarged scale and/or on a reduced scale.

The objective underlying the independent solutions proposed by the invention may be found in the associated parts of the description.

Above all, the individual embodiments of the subject matter illustrated in FIGS. 1 to 5; 6; 7; 8; 9; 10; 11; 12, 13, 14, 15; 16 to 19; 20; 21; 22, 23, 24; 25; 26, 27; 28; 29; 30 to 37 may be construed as independent solutions proposed by the invention. The associated objectives and solutions proposed by the invention may be found in the detailed descriptions.

### List of Reference Numbers

| | |
|---|---|
| 1 | Steering column tube |
| 2 | Cutout |
| 3 | Part |
| 4 | Part |
| 5 | End face |
| 6 | End face |
| 7 | Bearing receiving point |
| 8 | Bearing receiving point |
| 9 | Bearing |
| 10 | Bearing |
| 11 | Internal diameter |
| 12 | External diameter |
| 13 | Width |
| 14 | Outer ring |
| 15 | Steering shaft |
| 16 | Steering shaft mid-line |
| 17 | Surface |
| 18 | Bore |
| 19 | Bore |
| 20 | Reinforcing strip |
| 21 | Base |
| 22 | Height |
| 23 | Height |
| 24 | End face |
| 25 | End face |
| 26 | Dividing plane |
| 27 | Axis of symmetry |
| 28 | Wall thickness |
| 29 | Wall thickness |
| 30 | Cross section |
| 31 | Top edge |
| 32 | Width dimension |
| 33 | External dimension |
| 34 | Side leg |
| 35 | Angle |
| 36 | Intermediate part |
| 37 | External dimension |
| 38 | End part |
| 39 | Hollow throat |
| 40 | External face |
| 41 | Internal face |
| 42 | Cross section |
| 43 | Side leg |
| 44 | External dimension |
| 45 | Length |
| 46 | Width |
| 47 | Thickness |
| 48 | Width |
| 49 | Length |
| 50 | Cutout |
| 51 | Width |
| 52 | Length |
| 53 | Side face |
| 54 | Angle |
| 55 | End face |
| 56 | End face |
| 57 | Distance |
| 58 | Range |
| 59 | Bore |
| 60 | Diameter |
| 61 | Damping element |
| 62 | External dimension |
| 63 | Intermediate part |
| 64 | End part |
| 65 | Cross section |
| 66 | Width dimension |
| 67 | Side leg |
| 68 | End part |
| 69 | Base |
| 70 | Side leg |
| 71 | Initial part |
| 72 | Intermediate part |
| 73 | End part |
| 74 | Wall thickness |
| 75 | Height |
| 76 | Cross section |
| 77 | External diameter |
| 78 | Side leg |
| 79 | End part |
| 80 | Flange |
| 81 | Cutout |
| 82 | Flange |
| 83 | External dimension |
| 84 | Internal diameter |
| 85 | External diameter |
| 86 | Hollow throat |
| 87 | Individual part |
| 88 | Endpart |
| 89 | Hollow throat |
| 90 | Wall thickness |
| 91 | Shaped body |
| 92 | Strip |
| 93 | Top face |
| 94 | Side leg |
| 95 | Height |
| 96 | Intermediate part |
| 97 | End part |
| 98 | Internal diameter |
| 99 | External diameter |
| 100 | Opening slit |
| 101 | Width |
| 102 | Length |
| 103 | Width |
| 104 | Length |
| 105 | End face |
| 106 | End face |
| 107 | Flange |
| 108 | Height |
| 109 | Distance |
| 110 | End face |
| 111 | Hollow throat |
| 112 | Bearing receiving point |
| 113 | Bearing unit |
| 114 | Outer ring |
| 115 | Cage |
| 116 | Anti-friction element |
| 117 | Inner ring |
| 118 | External diameter |
| 119 | Joining element |
| 120 | Sleeve |
| 121 | Slit |
| 122 | Bore |
| 123 | Coil spring |
| 124 | Bearing box |
| 125 | Steering column tube |
| 126 | Joining region |
| 127 | Part |
| 128 | Part |
| 129 | Longitudinal end face |
| 130 | Longitudinal end face |
| 131 | End region |
| 132 | End region |
| 133 | Receiving region |
| 134 | Receiving region |
| 135 | Bearing receiving point |
| 136 | Bearing receiving point |
| 137 | Bearing part |
| 138 | Material recess |
| 139 | Cutout |
| 140 | Side leg |
| 141 | Stiffening region |
| 142 | Mounting flange |
| 143 | Support arm |
| 144 | Leg |
| 145 | Support arm part |
| 146 | Width dimension |
| 147 | Cutout |
| 148 | Cut and/or punched and/or bent part |
| 149 | Bending line |
| 150 | Transition region |
| 151 | Stiffening element |
| 152 | Stiffening element |
| 153 | Base |
| 154 | Apex |
| 155 | Height |
| 156 | Angle |
| 157 | Angle |
| 158 | Axis of symmetry |
| 159 | Intermediate part |
| 160 | End part |
| 161 | Wall thickness |
| 162 | Bearing plate |
| 163 | Shaped tube |
| 164 | Bearing plate |
| 165 | Bearing plate leg |
| 166 | Bearing element |
| 167 | Bearing element |
| 168 | Steering shaft portion |
| 169 | Steering shaft portion |
| 170 | External diameter |
| 171 | Internal diameter |
| 172 | Bearing point |
| 173 | Shoulder |
| 174 | External dimension |
| 175 | Bearing point |
| 176 | Receiving region |
| 177 | Bearing receiving point |
| 178 | Intermediate region |
| 179 | Slit |
| 180 | Receiving segment |
| 181 | External diameter |
| 182 | Intermediate part |
| 183 | Bearing part (outer ring) |
| 184 | Bearing part (inner ring) |
| 185 | Joining element |
| 186 | Overlap region |
| 187 | Outer ring |
| 188 | Inner ring |
| 189 | Longitudinal distance |
| 190 | Point |
| 191 | Measurement marker |
| 192 | Assembled dimension |
| 193 | |
| 194 | Bearing part width |
| 195 | Material split |
| 196 | Base plate |
| 197 | Peripheral land |
| 198 | Hollow cylindrical casing |
| 199 | Diameter |
| 200 | Bending radius |
| 201 | Shoulder part |
| 202 | Guide part |
| 203 | Adjustment range |
| 204 | Width |
| 205 | Width |
| 206 | Width |
| 207 | Wall thickness |
| 208 | Internal diameter |
| 209 | Width |
| 210 | Width |
| 211 | Shoulder part |
| 212 | Width |
| 213 | Adjustment range |
| 214 | Projection |
| 215 | Corner region |
| 216 | Internal dimension |
| 217 | Material split |
| 218 | Peripheral web |
| 219 | Hollow cylindrical casing |
| 220 | Guide part |
| 221 | Radius |
| 222 | Bearing receiving part |
| 223 | Guide part abutment surface |
| 224 | External dimension |
| 225 | Receiving region |
| 226 | Receiving compartment |
| 227 | Projection |
| 228 | Receiving segment |
| 229 | Arc length |
| 230 | Longitudinal side face |

1. Multi-part steering column tube with at least a top part and a bottom part, of which at least one part has a multi-cornered cross section in a plane perpendicular to its longitudinal extension, bearing receiving points being provided on the oppositely lying, mutually spaced end faces of the top and/or bottom part, which form a seamless, closed ring and the end faces of two side legs projecting out from the top part and/or the bottom part are joined to one another by means of at least one joining element, the bottom part (4) having a substantially U-shaped or trapezoid-shaped cross section (30, 42, 65, 76) in a plane perpendicular to the longitudinal extension of the steering column tube (1) and the bearing receiving points (7, 8, 112) being joined to the end faces (5, 6) of the steering column tube (1), with support plates to receive them disposed in between if necessary.

2. Multi-part steering column tube as claimed in claim 1, characterised in that the joining element between the two parts (3, 4) is provided at least in the form of a weld seam, preferably at least a laser or plasma welded seam.

3. Multi-part steering column tube as claimed in claim 1 or 2, characterised in that the joining element between the two parts (3, 4) is an adhesive layer.

4. Multi-part steering column tube as claimed in one or more of the preceding claims, characterised in that the joining element between the two parts (3, 4) is a soldered joint.

5. Multi-part steering column tube as claimed in one or more of the preceding claims, characterised in that the joining element between top part (3) and bottom part (4) is a fillet joint (39).

6. Multi-part steering column tube as claimed in one or more of the preceding claims, characterised in that the wall thickness (28) of the top part (3) or bottom part (4) is thicker than a wall thickness (29) of the bottom part (4) or top part (3).

7. Multi-part steering column tube as claimed in one or more of the preceding claims, characterised in that internal faces (41) of the top part (3) and the bottom part (4) are arranged in alignment.

8. Multi-part steering column tube as claimed in one or more of the preceding claims, characterised in that external faces (40) of the top part (3) and the bottom part (4) are arranged in line with one another.

9. Multi-part steering column tube as claimed in one or more of the preceding claims, characterised in that the top part (3) and/or the bottom part (4) is/are made from a planar cut piece by folding.

10. Multi-part steering column tube as claimed in one or more of the preceding claims, characterised in that an external dimension (33) of the top part (3) and an external dimension (44) of the bottom part (4) are different in the region of end the faces (24, 25) directed towards one another.

11. Multi-part steering column tube as claimed in one or more of the preceding claims, characterised in that an external dimension (33) of the top part (3) and an external dimension (44) of the bottom part (4) are of identical dimensions in the region of the end faces (24, 25) directed towards one another.

12. Multi-part steering column tube as claimed in one or more of the preceding claims, characterised in that a difference between the external dimensions (33, 44) of the top part (3) and bottom part (4) is greater than half of the wall thickness (28, 29).

13. Multi-part steering column tube as claimed in one or more of the preceding claims, characterised in that the top part (3) and/or the bottom part (4) are provided with strip-shaped end parts (38) in the region of the side legs (34) offset in the direction of an axis of symmetry (27).

14. Multi-part steering column tube as claimed in one or more of the preceding claims, characterised in that an external dimension (33) of the top part (3) and/or bottom part (4) is bigger between the end parts (38) and the base (21).

15. Multi-part steering column tube as claimed in one or more of the preceding claims, characterised in that a profiled, in particular closed or open steering column tube (1) has an end part (97) that is semicircular, for example.

16. Multi-part steering column tube as claimed in one or more of the preceding claims, characterised in that a strip-shaped end part (88) of the side legs (78) of the top part (3) is disposed at least at an angle to the axis of symmetry (27).

17. Multi-part steering column tube as claimed in one or more of the preceding claims, characterised in that the strip-shaped end parts (38) are joined to intermediate parts (36) by means of leg parts extending at least at an angle to and/or parallel with the axis of symmetry (27).

18. Multi-part steering column tube as claimed in one or more of the preceding claims, characterised in that a cutout (2) is provided in a base (21) of the top part (3) and/or in a base (69) of the bottom part (4), extending in the longitudinal direction thereof.

19. Multi-part steering column tube as claimed in one or more of the preceding claims, characterised in that a cutout (50) is provided in the reinforcing strip (20), which is of a length (52) and width (51) that are the same as or longer than the cutout (2) in the base (21, 69) of the top part (3) and/or bottom part (4).

20. Multi-part steering column tube as claimed in one or more of the preceding claims, characterised in that a reinforcing strip (20) is disposed between the two side legs (34, 43) on the base (21, 69) and is preferably joined to the base (21. 69).

21. Multi-part steering column tube as claimed in one or more of the preceding claims, characterised in that flanges (58) are provided in the end region of the cutout (50), extending substantially perpendicular to the reinforcing strip (20) projecting in the direction of the side legs (34, 43) of the top part (3) and/or the bottom part (4).

22. Multi-part steering column tube as claimed in one or more of the preceding claims, characterised in that damping elements (61) are provided on the flanges (58) in the region of the mutually facing sides thereof.

23. Multi-part steering column tube as claimed in one or more of the preceding claims, characterised in that the flanges (58) are made by means of bends in the reinforcing strip (20) and are disposed substantially perpendicular to the reinforcing strip (20) during a subsequent shaping process, in particular folding.

24. Multi-part steering column tube as claimed in one or more of the preceding claims, characterised in that the bottom part (4) is a seamless tube with a cutout (81).

25. Multi-part steering column tube as claimed in one or more of the preceding claims, characterised in that the bottom part (4) is single piece (87) that is a strip-shaped, rectangular in shape, etc., and the top part (3) sits on this bottom part (4) and is joined thereto.

26. Multi-part steering column tube as claimed in one or more of the preceding claims, characterised in that the steering column tube (1) is made in a single piece with the bearing receiving points (7, 8).

27. Multi-part steering column tube as claimed in one or more of the preceding claims, characterised in that the bends are shaped into substantially tubular, seamless bearing receiving points (7, 8).

28. Multi-part steering column tube as claimed in one or more of the preceding claims, characterised in that at least one of the two bearing receiving points (7, 8) has a bigger width (13).

29. Multi-part steering column tube as claimed in one or more of the preceding claims, characterised in that the joining element between the bearing receiving points (7, 8) on the steering column tube (1) and the top part (3) and/or bottom part (4) is provided in the form of at least one welded joint, preferably at least a laser or plasma welded joint.

30. Multi-part steering column tube as claimed in one or more of the preceding claims, characterised in that the reinforcing strip (20) is welded to one of the parts (3, 4) by means of a weld seam, and is preferably welded from outside.

31. Multi-part steering column tube as claimed in one or more of the preceding claims, characterised in that the joining element between the bearing receiving point (7, 8) on the steering column tube (1) and the top part (3) and/or bottom part (4) is preferably provided in the form of at least one adhesive layer.

32. Multi-part steering column tube as claimed in one or more of the preceding claims, characterised in that the joining element between the bearing receiving point (7, 8) on the steering column tube (1) and the top part (3) and/or the bottom part (4) is a soldered joint.

33. Multi-part steering column tube as claimed in one or more of the preceding claims, characterised in that the reinforcing strip (20) is joined to one of the parts (3, 4) by means of a soldered joint.

34. Multi-part steering column tube as claimed in one or more of the preceding claims, characterised in that the outer ring (114) for a bearing (9, 10), in particular for a ball bearing, is mounted on the end faces (5, 6) of the steering column tube (1), being disposed directly thereon.

35. Multi-part steering column tube as claimed in one or more of the preceding claims, characterised in that the flanges (107) formed by the strip (92) and disposed substantially perpendicular to the strip (92) are used to connect the bearing receiving points (7, 8), in particular are joined by a laser welded joint.

36. Multi-part steering column tube as claimed in one or more of the preceding claims, characterised in that the steering column tube (1) has one or more slits (121) and bores (122).

37. Multi-part steering column tube as claimed in one or more of the preceding claims, characterised in that at least one bearing (9, 10) is provided with a coil spring (123) and the steering shaft (15) is mounted without any clearance in the axial direction as a result.

38. Multi-part steering column tube as claimed in one or more of the preceding claims, characterised in that the cutout (2) is a substantially oblong hole and is provided as a means of receiving and guiding an adjusting mechanism.

39. Multi-part steering column tube as claimed in one or more of the preceding claims, characterised in that a height (22, 23) of the top or bottom part (3, 4), specifically measured perpendicular to the top edge (31), is higher than the height (23, 22) of the bottom or top part (3, 4).

40. Multi-part steering column tube having at least a first part and another part, of which at least one part has a multi-cornered cross section in a plane perpendicular to its longitudinal extension, receiving regions for bearing elements being provided on the oppositely lying, mutually spaced end regions of the first and/or other part, the abutting parts (127, 128) being joined to one another by means of at least one joining element (185) in a joining region (126) lying in a plane parallel with the perpendicular longitudinal mid-plane, and the receiving regions (133; 134; 176; 225) being formed by substantially shell-shaped bearing parts (137) integrally formed on the parts (127, 128).

41. Multi-part steering column tube as claimed in claim 40, characterised in that the parts (127, 128) are of a half-shell design.

42. Multi-part steering column tube as claimed in claim 40 or 41, characterised in that the parts (127, 128) are of a symmetrical design and the plane of the joining region (126) extends congruently with the longitudinal mid-plane of the steering column tube (125).

43. Multi-part steering column tube as claimed in one or more of claims 40 to 42, characterised in that one of the parts (127; 128) has several corners, being U-shaped in particular, and its longitudinal side edges extend from projecting legs parallel with and spaced apart from the vertical longitudinal mid-plane and the other part (128; 127) is preferably of a flat design and is joined thereto.

44. Multi-part steering column tube as claimed in one or more of claims 40 to 43, characterised in that the receiving region (225) is made up of several diametrically opposed arcuate receiving segments (228) with receiving compartments (226) for receiving at least certain regions of projections (227) of a bearing element (166; 167).

45. Multi-part steering column tube as claimed in one or more of claims 40 to 44, characterised in that each of the parts (127, 128) has several spaced apart receiving segments (228).

46. Multi-part steering column tube as claimed in one or more of claims 40 to 45, characterised in that the receiving regions (133, 134) forming the bearing receiving points (135, 136) are respectively provided with a material recess (138) extending across a part of a width.

47. Multi-part steering column tube as claimed in one or more of claims 40 to 46, characterised in that the receiving regions (176) forming the bearing receiving part (177) are provided in the form of receiving segments (180) extending concentrically around the longitudinal mid-axis (16) of the steering shaft (15) and separated from one another by diametrically opposed slits (179).

48. Multi-part steering column tube as claimed in one or more of claims 40 to 47, characterised in that an internal face or external face or end face (5; 6) on oppositely lying end regions (131, 132) on the steering column tube (125) is provided as a receiving region (133; 134; 176) for the bearing elements (166, 167).

49. Multi-part steering column tube as claimed in one or more of claims 40 to 48, characterised in that it is made from at least two single-piece cut and/or punched and/or bent parts (148).

50. Multi-part steering column tube as claimed in one or more of claims 40 to 49, characterised in that a frame-type support arm (143) is disposed on the steering column tube (125) to provide a pivotable mounting on a bodywork.

51. Multi-part steering column tube as claimed in one or more of claims 40 to 50, characterised in that the support arm (143) is integrally formed on the steering column tube (125) or is connected to it by means of a joining element (152).

52. Multi-part steering column tube as claimed in one or more of claims 40 to 51, characterised in that the support arm (143) has at least two oppositely lying legs (144) disposed on the parts (127, 128) with support arm parts (145) folded several times extending towards one another arranged in between them.

53. Multi-part steering column tube as claimed in one or more of claims 40 to 52, characterised in that the support arm parts (145) are joined to one another in the joining region (126) extending flush with the joining region (126) of the steering column tube (125).

54. Multi-part steering column tube as claimed in one or more of claims 40 to 53, characterised in that the legs (144) and at least one of the side legs (140) or parts (127; 128) are provided with a slit-type cutout (139, 147).

55. Multi-part steering column tube as claimed in one or more of claims 40 to 54, characterised in that the joining element between the two parts (127, 128) is provided by at least one welded joint, preferably at least a laser or plasma welded joint.

56. Bearing element, in particular for a steering shaft mounted in a steering column tube with a first bearing part and at least another bearing part, which are designed to be displaceable relative to one another via an intermediate part, in particular several intermediate parts, characterised in that a bearing part width (194) of at least one of the bearing parts ((183; 184) constitutes the sum of widths (204 to 206) of a guide part (202) receiving one of the intermediate parts (182) and an adjustment region (203) for providing an adjustment on and relative to the steering column tube (1; 125) and a shoulder part (201) overlapping with at least a part of a receiving region (176) on the steering column tube (1; 125).

57. Bearing element as claimed in claim 56, characterised in that the bearing part (183) forming an outer ring (187) and the bearing part (184) forming an inner ring (188) is of a substantially shell-shaped or pot-shaped design.

58. Bearing element as claimed in claim 56 or 57, characterised in that a base plate (196) bounding the bearing part width (194) of the bearing part (183) is provided with a material split (195) and a remaining peripheral web (197) is provided as a bearing region for the intermediate parts (182).

59. Bearing element as claimed in one or more of claims 56 to 58, characterised in that the bearing parts (183, 184) are made from a deep-drawn and/or punched and/or folded part.

60. Bearing element as claimed in one or more of claims 56 to 59, characterised in that a region of the guide part (202) and the bearing region of the outer ring (187) has an arcuate, convex contour directed towards the intermediate parts (182).

61. Bearing element as claimed in one or more of claims 56 to 60, characterised in that a bending radius (200) of the guide part (202) is more or less the same as a diameter (199) of the intermediate part (182).

62. Bearing element as claimed in one or more of claims 56 to 61, characterised in that the shoulder part (201) and adjustment region (203) are respectively formed by a concentric annular portion of identical dimensions extending around a longitudinal mid-axis (16).

63. Bearing element as claimed in one or more of claims 56 to 62, characterised in that it is provided with a radial widening of a certain width in its longitudinal contour, starting from the adjustment region (203), in the direction of the guide part (202).

64. Bearing element as claimed in one or more of claims 56 to 63, characterised in that it is provided with a radial tapering of a certain width in its longitudinal contour, starting from the adjustment region (203), in the direction of the guide part (202).

65. Bearing element as claimed in one or more of claims 56 to 64, characterised in that the guide part (202) and the shoulder part (201) respectively constitute a separate component and one of the shoulder and guide parts (201; 202) forms the adjustment region (203) and the latter are joined to one another by means of a joining element in a positive and/or force-fit arrangement.

66. Bearing element as claimed in one or more of claims 56 to 65 characterised in that the bearing part or parts (183, 184) is or are made from a wear-resistant plastics materials with a high bearing capacity.

67. Bearing element as claimed in one or more of claims 56 to 66, characterised in that the adjustment region (203) has a width (205) of approximately 0.5 mm to 10 mm, in particular between 0.7 mm and 4 mm.

68. Bearing element as claimed in one or more of claims 56 to 67, characterised in that the adjustment region (203) is designed to extend the steering column tube (1; 125) to a width (205) of between 5 mm to 100 mm.

69. Bearing element as claimed in one or more of claims 56 to 68, characterised in that the bearing part (183) and the outer ring (187) have a constant wall thickness (207) along their longitudinal extension.

70. Bearing element as claimed in one or more of claims 56 to 69, characterised in that the shoulder part (201) and adjustment region (203) of the bearing part (183), in particular the outer ring (187), is formed by several diametrically opposite arcuate projections (227) having and being mutually separated by receiving compartments for receiving at least certain regions of receiving segments (228) of a receiving region (225).

71. Steering column tube for a steering shaft with at least two receiving regions for the bearing elements spaced apart from one another in the longitudinal direction of the steering shaft and specifically arranged in the end regions, in particular as claimed in one of claims 1 or 40, characterised in that a width (209) of at least one of the receiving regions (133, 134; 176; 225) comprises the sum of widths (210, 212) of a shoulder part (211) and an adjustment region (213) for adjusting the steering column tube (1; 125) relative to the bearing part (183; 184).

72. Steering column tube as claimed in claim 71, characterised in that the receiving region (133, 134; 176, 225) is a part-region of the steering column tube (125).

73. Steering column tube as claimed in claim 71 or 72, characterised in that the receiving region (133, 134; 176, 225) is formed by bearing receiving points (7, 8; 135; 177) disposed on distal end regions (131, 132).

74. Steering column tube as claimed in one or more of claims 71 to 73, characterised in that it comprises a shaped tube with a circular cross section in a plane perpendicular to its longitudinal extension and forms the receiving regions (133, 134) for the bearing elements (166, 167) at the distal end regions (131, 132).

75. Steering column tube as claimed in one or more of claims 71 to 74, characterised in that the adjustment region (213) has a width (212) of between approximately 0.5 mm and 10 mm, in particular between 0.7 mm and 4 mm.

76. Bearing box for mounting a steering shaft with a steering column tube at least partially enclosing the steering shaft, co-operating with at least two bearing elements between the steering shaft and the steering column tube provided in the end regions of the steering column tube spaced at a distance apart from one another and receiving the steering shaft that it can be displaced in rotation, and the bearing element is provided in the form of at least two bearing parts displaceable relative to one another via an intermediate part, characterised in that it incorporates at least one of the bearing elements (166, 167) as claimed in one or more of claims 56 to 70 and/or the steering column tube (1; 125) as claimed in one or more of claims 71 to 75 and at least one of the bearing parts (183; 184) of at least one bearing element (166; 167) and/or the steering column tube (1; 125) is displaceable in a direction parallel with the longitudinal direction of the steering shaft (15) and at least one bearing part (183; 184) and/or the steering column tube (1; 125) can be adjusted between a point (190) and a measurement marker (191) to set and conform to a mounted dimension (192).

77. Bearing box as claimed in claim 76, characterised in that a bearing element (166; 167) is positioned by means of at least one bearing point (172), for example a shoulder (173), co-operating with at least one of the bearing parts (183; 184) and the steering column tube (1; 125) is displaceable relative to the positioned bearing element (166; 167).

78. Bearing box as claimed in claim 76 or 77, characterised in that the point (190) on the steering column tube (1; 125) is provided in the form of a component, for example a fixing element for fixing it to a bodywork.

79. Bearing box as claimed in one or more of claims 76 to 78, characterised in that the measurement marker (191) is predetermined on the basis of an end-face region of the steering shaft (15), for example.

80. Bearing box as claimed in one or more of claims 76 to 79, characterised in that a maximum bearing part width (194) of the bearing part (183) is at least slightly smaller than a minimum width (209) of a receiving region (176) of the steering column tube (1; 125).

81. Bearing box as claimed in one or more of claims 76 to 80, characterised in that a minimum width (212) of the adjustment region (213) on the steering column tube (1; 125) is at least slightly bigger than a maximum width (205) of the adjustment region (203) on the bearing part (183).

82. Bearing box as claimed in one or more of claims 76 to 81, characterised in that an internal face of the bearing part (183) having an internal diameter (208) and concentrically extending around a longitudinal mid-axis (16) of the steering shaft (15) is bounded by an external face of the receiving region (133. 134; 176) with an external diameter (181) extending concentrically around a longitudinal mid-axis (16).

83. Bearing box as claimed in one or more of claims 76 to 82, characterised in that an inner ring (188) has several part-sections, one of which part-sections is designed to overlap with the steering shaft (15) in a positive-fit arrangement, at least in certain regions.

84. Bearing box as claimed in claim 83, characterised in that the other part-section has a cylindrical cross section in a plane perpendicular to its longitudinal extension, the surface thereof remote from the steering shaft (15) being used as a bearing surface for the intermediate parts (182).

85. Bearing box as claimed in one or more of claims 76 to 84, characterised in that the bearing part (184) and the inner ring (188) forming it is joined to the steering shaft (15) in a positive and/or force-fit arrangement by means of at least one joining element (185).

86. Bearing box as claimed in one or more of claims 76 to 85, characterised in that the bearing part (183) and the outer ring (187) forming it is joined to the receiving region (133, 134; 176) in a positive and/or force-fit arrangement by means of at least one joining element (185).

87. Bearing box as claimed in one or more of claims 76 to 86, characterised in that the joining element (185) is disposed in the overlap region (186) and joining region at least at intermittent points or continuously around the entire circumference of the receiving region (133, 134; 176) and bearing part (183; 184) or the steering shaft (15).

88. Bearing box as claimed in one or more of claims 76 to 87, characterised in that the joining element (185) is provided in the form of a welded joint, preferably at least a laser or plasma welded joint.

89. Bearing box as claimed in one or more of claims 76 to 88, characterised in that the joining element (185) is provided in the form of an adhesive layer.

90. Bearing box as claimed in one or more of claims 76 to 89, characterised in that the joining element (185) is provided in the form of a soldered joint.

91. Bearing box as claimed in one or more of claims 76 to 90, characterised in that the joining element (185) is provided in the form of a pressed joint or by clinching.

92. Bearing box as claimed in one or more of claims 76 to 91, characterised in that once a predetermined mounted dimension (192) has been fixed by adjusting at least one bearing part (183) of the other bearing element (167), a longitudinal distance (189) can be adjusted between the oppositely lying bearing elements (166, 167).

93. Bearing box as claimed in one or more of claims 76 to 92, characterised in that projections (227) project alternately out from the bearing part (183) into receiving compartments (226) of the receiving regions (225) and receiving segments (228) of the steering column tube (125) locate in receiving compartments of the bearing part (183).

94. Bearing box as claimed in one or more of claims 76 to 93, characterised in that the joining region (126) is formed by longitudinal side faces (230) of the receiving segment (228) and bearing part (183) abutting flat with one another.

95. Bearing box for mounting a steering shaft with a steering column tube at least partially enclosing the steering shaft, co-operating with at least two bearing elements between the steering shaft and the steering column tube, provided in the end regions of the steering column tube spaced at a distance apart from one another and receiving the steering shaft such that it can be displaced in rotation, and the bearing element is provided in the form of at least two bearing parts displaceable relative to one another via an intermediate part, characterised in that at least one of the bearing parts (183; 184) of at least one bearing element (166, 167) is formed by a part-region of the steering column tube (125).

96. Bearing box as claimed in claim 95, characterised in that the bearing part (183; 184) is formed by a material widening.

97. Bearing box as claimed in claim 95 or 96, characterised in that the substantially pot-shaped steering column tube (125) is provided with a material split (217).

98. Bearing box as claimed in one or more of claims 95 to 97, characterised in that a transition region from a smaller to a larger or a larger to a smaller cross-sectional dimension is used as a guide part (202) for the intermediate parts (182).

99. Bearing box as claimed in one or more of claims 95 to 98, characterised in that the steering column tube (125) has a cylindrical cross section in a plane perpendicular to its longitudinal extension.

100. Bearing box as claimed in one or more of claims 95 to 99, characterised in that the steering column tube (125) is made from a drawn and/or deep-drawn and/or folded part made from metal material.

101. Bearing box as claimed in one or more of claims 95 to 100, characterised in that the part-region of the steering column tube (125) in which the bearing element (166; 167) is provided is heat-treated.

102. Bearing box as claimed in one or more of claims 95 to 101, characterised in that the steering column tube (125) is made from an injection-moulded part, etc., made from plastics.

103. Bearing box as claimed in one or more of claims 95 to 102, characterised in that the part-region is calibrated.

104. Method of assembling bearing elements of a bearing box, whereby several bearing elements can be positioned and fixed at a distance apart from one another in the direction of a longitudinal axis of a steering shaft, characterised in that a bearing element (166; 167) designed to rotatably mount a steering shaft (15) is pushed onto at least one receiving region (133; 134; 176; 225) of a steering column tube (1; 125) and a bearing point (172; 175) of the steering shaft (15) and a pre-specified mounted dimension (192) between a point (190) on the steering column tube (1; 125) and a measurement marker (191) on the steering shaft (15) can be set and, once the steering shaft (15) has been positioned and adjusted relative to the steering column tube (1; 125), at least one of the bearing parts (183; 184) of the first bearing element (166) is joined to the receiving region (133; 134; 176; 225) in a positive and/or force-fit arrangement in the overlap region (186) by means of a joining element (185), after which the other bearing element (167) lying opposite the bearing element (166) is adjusted in terms of its position relative to the first bearing element (166) and then fixed.

105. Method as claimed in claim 104, characterised in that the predeterminable measurement marker (191) is pre-set by means of a bearing point (172) provided on the steering shaft (15) or a free dimension.

106. Method as claimed in claim 104 or 105, characterised in that one of the bearing parts (183) of the first bearing element (166) is positioned in the longitudinal direction on the steering shaft (15) against a shoulder (173) on the steering shaft (15), after which the steering column tube (1; 125) is positioned and adjusted relative to the steering shaft (15) and the other bearing part (184) is joined, in its position, to the steering column tube (1; 125) in a positive and/or force-fit arrangement.

107. Method as claimed in one or more of claims 104 to 106, characterised in that the other displaceable bearing element (167) is held in position during a pre-definable run-in phase and is further adjusted relative to the first bearing element (166) if necessary until a predeterminable mechanical desired value is obtained whereby at least one of the bearing parts (183; 184) of the bearing element (167) is joined to the receiving region (133; 134; 176; 225) of the steering column tube (1; 125) and/or the steering shaft (15) in its adjusted position by means of a joining element (185) in a positive and/or force-fit arrangement.

108. Method as claimed in one or more of claims 104 to 107, characterised in that the positive-fit and/or force-fit joining element (185) is provided in the form of a laser welded joint, preferably without using additional material.

109. Method as claimed in one or more of claims 104 to 108, characterised in that the steering shaft (15) is slightly pre-tensioned by shortening the longitudinal distance (189) between the oppositely lying bearing elements (166, 167)

110. Method as claimed in one or more of claims 104 to 109, characterised in that the desired value is set by means of the measurable pre-tensioning in the steering shaft (15).

111. Method as claimed in one or more of claims 104 to 110, characterised in that the desired value is set by means of the measurable rolling friction applied to turn the steering shaft (15).
